(19) United States
(12) Patent Application Publication
(10) Pub. No.: US 2010/0155650 A1
(43) Pub. Date: Jun. 24, 2010

(54) Amidine-carboxylic acid complex, briged polynuclear complex derived therefrom, production methods therefor, and use for preparing supported metal or metal oxide clusters

(76) Inventors: Kazushi Mashima, Osaka (JP); Masato Ohashi, Osaka (JP); Akihiro Yagyu, Osaka (JP); Hirohito Hirata, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/308,050

(22) PCT Filed: Jun. 7, 2007
(86) PCT No.: PCT/IB2007/002409

§ 371 Date: Aug. 31, 2009

(30) Foreign Application Priority Data
Jun. 7, 2006 (JP) 2006-158368
Jul. 12, 2006 (JP) 2006-191817

(51) Int. Cl. H01F 1/04; H01F 1/00; C01B 13/14; B01J 23/42; C07F 15/00; C22B 5/00

(52) U.S. Cl. 252/62.55; 252/62.51 R; 423/592.1; 502/339; 556/137; 75/711

(57) ABSTRACT

An amidine-carboxylic acid complex in accordance with an aspect of the invention has an amidine ligand and a carboxylic acid ligand that are coordinated to one metal atom or a plurality of metal atoms of the same element. A multiple-complex-containing compound, i.e. a bridged polynuclear complex, in accordance with the aspect of the invention is formally derived from two or more such amidine-carboxylic acid complexes, linked by a polyvalent carboxylic acid ligand. The bridged polynuclear complex may be used in a production method to support metal (oxide) clusters on a porous support by impregnating these with a solution thereof, followed by drying and firing.

### BACKGROUND OF THE INVENTION

1. Field of the Invention

The invention relates to an amidine-carboxylic acid complex, a multiple-complex-containing compound, and production methods for the complex and the compound. The invention also relates to a method for producing a metal or metal oxide cluster having a controlled cluster size through the use of the multiple-complex-containing compound of the invention.

2. Description of the Related Art

According to recent studies, a metal cluster having a controlled size is different from a bulk metal in chemical characteristics, such as catalytic activity and the like, and physical characteristics, such as magnetism and the like.

In order to utilize the peculiar characteristics of the metal cluster, a method for easily synthesizing a size-controlled cluster in large amount is needed. In a known method for obtaining a size-controlled cluster, clusters of various sizes are formed by causing a metal target to evaporate in vacuum, and the thus-obtained clusters are separated according to cluster sizes through the use of the principle of the mass spectrum. However, this method is not able to easily synthesize a cluster having a controlled size in large amount.

With regard to the peculiar characteristics of the cluster, for example, “Adsorption and Reaction of Methanol Molecule on Nickel Cluster Ions, Niₙ⁺ (n=3-11)”, M. Ichihashi, T. Hanmura, R. T. Yadav, and T. Kondow, J. Phys. Chem. A, 104, 11885 (2000) (document 1), discloses that the reactivity between methane molecules and platinum catalyst in the gas phase is greatly affected by the platinum cluster size, and there exists a particular platinum cluster size that is optimal for the reaction, as shown FIG. 1.

Examples of utilization of the catalytic performance of a noble metal include purification of exhaust gas discharged from an internal combustion engine, such as an automotive engine or the like. In the purification of exhaust gas, exhaust gas components, such as carbon monoxide (CO), hydrocarbon (HC), nitrogen oxide (NOₓ), etc., are converted into carbon dioxide, nitrogen and oxygen by catalyst components whose main component is a noble metal such as platinum (Pt), rhodium (Rh), palladium (Pd), iridium (Ir), etc. Generally in the use for exhaust gas purification, the catalyst component that is a noble metal is supported on a support made of an oxide, such as alumina or the like, so as to provide a large contact area for exhaust gas and the catalyst component.

The supporting of the catalyst component that is a noble metal on the oxide support is accomplished generally by impregnating the oxide support with a solution of a nitric acid salt of a noble metal or a noble metal complex having one noble metal atom so that the noble metal compound is dispersed on surfaces of the oxide support, and then drying and firing the support impregnated with the solution. In this method, however, it is not easy to obtain a noble metal cluster that has an intended size or an intended number of atoms.

With regard to such catalysts for exhaust gas purification, too, the supporting of a noble metal in the form of clusters has been proposed in order to further improve the exhaust gas purification capability. For example, Japanese Patent Application Publication No. JP-A-11-285644 (document 2) discloses a technology in which the use of a metal cluster complex that has a carbonyl group as a ligand makes it possible to support a catalytic metal in the form of ultrafine particle directly on a support.

Furthermore, Japanese Patent Application Publication No. JP-A-2003-181288 (document 3) discloses a technology in which a noble metal catalyst having a controlled cluster size is produced by introducing a noble metal into pores of a hollow carbon material, such as carbon nanotube or the like, and fixing the carbon material with the introduced noble metal to an oxide support, and then firing it.

Still further, Japanese Patent Application Publication No. JP-A-9-253490 (document 4) discloses a technology in which a metal cluster made up of an alloy of rhodium and platinum dissolved in the solid state is obtained by adding a reductant to a solution containing rhodium ions and platinum ions.

Furthermore, Japanese Patent Application Publication No. JP-A-2006-55807 (document 5) discloses a noble metal cluster-supported catalyst production method in which a noble metal cluster-supported catalyst is produced by causing a polynuclear complex made up of a plurality of organic polydentate ligands and a plurality of noble metal atoms to deposit on an oxide support, and then removing the organic polydentate ligands. This document also discloses a production method for a noble metal cluster-supported catalyst which includes reacting an organic polydentate ligand and the hydroxyl group on an oxide support surface so as to bind the organic polydentate ligand to the oxide support, and reacting the organic polydentate ligand with the noble metal atom or another organic polydentate ligand so as to form a polynuclear complex that is bound to the oxide support, and then removing the organic polydentate ligand of the polynuclear complex.

With regard to the metal complex, obtaining a polymer having an infinite number of metal atoms through the use of a polyvalent ligand is known. For example, Japanese Patent Application Publication No. JP-A-2000-109485 discloses a technology for obtaining a dicarboxylic acid metal complex polymer having a giant three-dimensional structure through the use dicarboxylic acid.

### SUMMARY OF THE INVENTION

The invention provides a novel multiple-complex-containing compound that makes it possible to easily synthesizing a size-controlled metal or metal oxide cluster in large amount, and a metal complex capable of being used for the synthesis of the aforementioned compound. The invention also provides a method for producing the multiple-complex-containing compound and the complex.

A first aspect of the invention relates to an amidine-carboxylic acid complex that an amidine ligand and a carboxylic acid ligand are coordinated to one metal atom or a plurality of metal atoms of the same element.

According to the foregoing aspect, the multiple-complex-containing compound can be obtained by substituting partially the ligands of the amidine-carboxylic acid complex with a polyvalent carboxylic acid ligand. In this case, the polyvalent carboxylic acid ligand selectively substitutes the carboxylic acid ligand, not the amidine ligand. The amidine ligand has a stronger tendency to be coordinated to a metal atom than the carboxylic acid ligand, and therefore is less likely to be substituted by a dicarboxylic acid ligand.

Thus, since the polyvalent carboxylic acid ligand is able to substitute only the carboxylic acid ligand of the amidine-carboxylic acid complex of the invention that is used as a raw material, that is, it is able to substitute only partially or only one or more of the ligands, the number of structural isomers of the multiple-complex-containing compound obtained as a product of the amidine-carboxylic acid complex becomes relatively small. This makes it easier to separate an intended multiple-complex-containing compound from unreacted complexes and multiple-complex-containing compounds that have more or fewer complexes than the intended multiple-complex-containing compound, through a purification process such as recrystallization or the like.

Since the polyvalent carboxylic acid ligand is able to substitute only partially or only some of the ligands of the complex of the invention used as a raw material, it is possible to curb the production of giant multiple-complex-containing compounds made up of a myriad of complexes that are bound to each other.

A second aspect of the invention relates to a production method for an amidine-carboxylic acid complex including (a) providing a carboxylic acid complex in which a plurality of carboxylic acid ligands are coordinated to one metal atom or a plurality of metal atoms of the same element, (b) providing an amidine ligand supply force, and (c) substituting partially the carboxylic acid ligands of the carboxylic acid complex with an amidine ligand by mixing the carboxylic acid complex and the amidine ligand source in a solvent.

According to the aspect, an amidine-carboxylic acid complex of the invention can be produced.

A third aspect of the invention relates to a multiple-complex-containing compound that is made up so that a plurality of amidine-carboxylic acid complexes selected from the group consisting of the aforementioned amidine-carboxylic acid complexes and their combinations are bound to each other via polyvalent carboxylic acid ligands substituting at least partially the carboxylic acid ligands.

According to the aspect, the number of structural isomers that can exist is small, in comparison with a multiple-complex-containing compound that does not have an amidine ligand but has only carboxylic acid ligands. This is because the amidine ligand has a stronger tendency to be coordinated to a metal atom than the carboxylic acid ligand, and therefore is less likely to be substituted. Therefore, a polyvalent carboxylic acid ligand selectively substitutes the carboxylic acid ligand.

Since the number of structural isomers that can exist is relatively small regarding the multiple-complex-containing compound of the invention, the production of unintended products can be curbed when the multiple-complex-containing compound is used as a homogeneous system catalyst in a solvent. Furthermore, since the number of structural isomers that can exist is relatively small, it becomes easier to separate an intended multiple-complex-containing compound from unreacted complexes and multiple-complex-containing compounds that have more or fewer complexes than the intended multiple-complex-containing compound, through a purification process such as recrystallization or the like.

Furthermore, according to the multiple-complex-containing compound of the invention, when ligands of this compound are removed by firing or the like, a metal or metal oxide cluster that has the same number of metal atoms as contained in this compound can be obtained.

A fourth aspect of the invention relates to a production method for a multiple-complex-containing compound including (a) providing an amidine-carboxylic acid complex selected from the group consisting of the aforementioned amidine-carboxylic acid complexes and their combinations, (b) providing a polyvalent carboxylic acid ligand source, and (c) substituting at least partially the carboxylic acid ligand of the amidine-carboxylic acid complex with a polyvalent carboxylic acid ligand by mixing the amidine-carboxylic acid complex and the polyvalent carboxylic acid ligand source in a solvent.

According to the aspect, a multiple-complex-containing compound of the invention can be obtained. It is to be noted herein that the term “ligand source” in this specification means a compound that provides a corresponding ligand when dissolved in a solvent.

A fifth aspect of the invention relates to a production method for a metal or metal oxide cluster including (a) providing a solution containing a multiple-complex-containing compound as mentioned above, and (b) removing a ligand of the multiple-complex-containing compound.

According to the aspect, a metal or metal oxide cluster having the same number of metal atoms as the multiple-complex-containing compound does can be obtained. Furthermore, according to this method, the configuration of the obtained metal or metal oxide cluster can also be controlled by using the multiple-complex-containing compound as mentioned above, that is, the multiple-complex-containing compound that has relatively few structural isomers that can exist.

### BRIEF DESCRIPTION OF THE DRAWINGS

The foregoing and/or further objects, features and advantages of the invention will become more apparent from the following description of preferred embodiment with reference to the accompanying drawings, in which like numerals are used to represent like elements and wherein:

FIG. 1 is a graph showing a relationship between the Pt cluster size and the reactivity extracted from the aforementioned Document 1;

FIG. 2 is a scheme showing the syntheses of a trans-2-substituted complex of octaacetatotetraplatinum in accordance with Example 1 of invention;

FIG. 3 shows a single crystal structure of a product in accordance with Example 1 of the invention;

FIG. 4 shows results of the X-ray diffraction analysis of the single crystal structure of the product in accordance with Example 1;

FIG. 5 is a scheme showing the syntheses of a dimer (platinum (Pt) 8-nuclear complex) from a trans-2-substituted complex of octaacetatotetraplatinum in accordance with Example 4 of the invention;

FIG. 6 is a scheme showing the syntheses of a trimer (platinum 12-nuclear complex) from a trans-2-substituted complex of octaacetatotetraplatinum in accordance with Example 5 of the invention;

FIG. 7 is a scheme showing the syntheses of a tetramer (platinum 16-nuclear complex) from a trans-2-substituted complex of octaacetatotetraplatinum in accordance with Example 6 of the invention;

FIG. 8 is a scheme showing the syntheses of a pentamer (platinum 20-nuclear complex) from a trans-2-substituted complex of octaacetatotetraplatinum in accordance with Example 7 of the invention;

FIG. 9 is a scheme showing the syntheses of bidentate ligand {1,3-bis(p-methoxyphenylbenzamidino)propane}(H₂DAniBp) for cis-2-substitution in accordance with Example 8 of the invention;

FIG. 10 is a scheme showing the syntheses of a cis-2-substituted complex of octaacetatotetraplatinum in accordance with Example 9 of the invention;

FIG. 11 shows a single crystal structure of a product in accordance with Example 9 of the invention;

FIG. 12 shows results of the X-ray diffraction analysis of the single crystal structure of a product in accordance with Example 1 of the invention;

FIG. 13 is a scheme showing the syntheses of a tetramer (platinum (Pt) 16-nuclear complex) from a cis-2-substituted complex of octaacetatotetraplatinum in accordance with Example 10 of the invention;

FIG. 14 is a ¹H-NMR spectrum chart of the cis-2-substituted complex of octaacetatotetraplatinum and the tetramer of the cis-2-substituted complex that are the raw material and the product, respectively, of Example 10 of the invention;

FIG. 15 is a ¹H-NMR spectrum chart of the tetramer that is a product of Example 1;

FIG. 16 shows a TEM photograph in which the appearance of Pt on MgO prepared by the method of Reference Example 1;

FIG. 17 is a scheme showing the syntheses of a dimer [Pt₄(CH₃COO)₇{O₂C(CH₂)₃CH═CH(CH₂)₃CO₂}(CH₃COO)₇Pt₄] of octaacetatotetraplatinum of Reference Example 2;

FIG. 18 is a scheme showing the syntheses of a dimer [Pt₄(CH₃COO)₇{O₂C(CH₂)₃CH═CH(CH₂)₃CO₂}(CH₃COO)₇Pt₄] of octaacetatotetraplatinum of Reference Example 2;

FIG. 19 is a TEM photograph in which the appearance of Pt on MgO prepared by the method of Reference Examples 2 was observed.

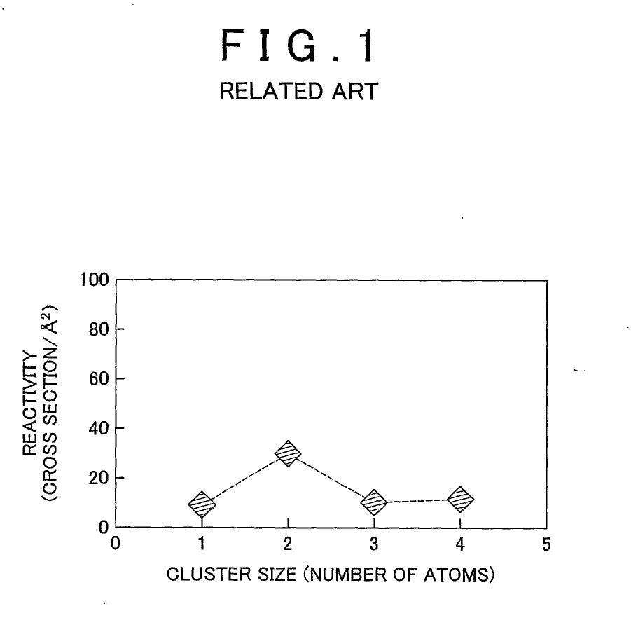

### DETAILED DESCRIPTION OF THE PREFERRED EMBODIMENTS

In the following description, the present invention will be described in more detail in terms of exemplary embodiments.

The amidine-carboxylic acid complex in accordance with an embodiment of the invention has an amidine ligand and a carboxylic acid ligand that are coordinated to one metal atom or a plurality of metal atoms of the same element.

The amidine ligand and the carboxylic acid ligand of the amidine-carboxylic acid complex in accordance with the embodiment of the invention may be arbitrarily selected, taking into account the physical properties, structure, etc., of the amidine-carboxylic acid complex. That is, the amidine ligand and the carboxylic acid ligand may be a unidentate ligand provided by a monovalent amidine or a monovalent carboxylic acid, or may also be a polydentate ligand, such as a chelate ligand provided by a polyvalent amidine and a polyvalent carboxylic acid.

The carboxylic acid ligand of the amidine-carboxylic acid complex in accordance with the embodiment of the invention may be an arbitrary carboxylic acid ligand capable of forming an amidine-carboxylic acid complex and, particularly, a monovalent carboxylic acid ligand. Examples of the carboxylic acid ligand include carboxylic acid ligands represented by the following formula:

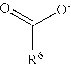

In the formula, R⁶ represents hydrogen, or a substituted or non-substituted alkyl group, alkenyl group, alkynyl group, aryl group, alicyclic group or aralkyl group.

For example, R⁶ may be hydrogen, or a substituted or non-substituted alkyl group, alkenyl group, alkynyl group, aryl group, alicyclic group or aralkyl group of C₁ to C₃₀ (i.e., a carbon atom number of 1 to 30 (which also applies below), and particularly of C₁ to C₁₀. Furthermore, R₆ may also be hydrogen, or an alkyl group, an alkenyl group, or an alkynyl group of C₁ to Cₛ, and particularly of C₁ to C₃.

Concrete examples of the carboxylic acid ligand include a formic acid (formato) ligand, an acetic acid (acetato) ligand, a propionic acid (propionato) ligand, and an ethylenediaminetetra-acetic acid ligand.

The amidine ligand of the amidine-carboxylic acid complex in accordance with the embodiment of the invention may be a monovalent or polyvalent amidine ligand represented by the following formula:

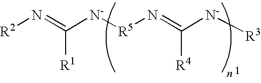

In the formula, R¹ to R⁴ independently represent hydrogen, or a substituted or non-substituted alkyl group, alkenyl group, alkynyl group, aryl group, alicyclic group or aralkyl group. R⁵ represents an alkylene group, an alkenylene group, an alkynylene group, an arylene group, an aralkylene group or a bivalent alicyclic group. n¹ represents an integer of 0 to 5.

R¹ and R⁴, each of which is a substituent group on carbon in the amidine ligand, may independently be hydrogen, or a substituted or non-substituted alkyl group, alkenyl group, alkynyl group, aryl group, alicyclic group or aralkyl group of C₁ to C₁₀, and particularly, may be hydrogen, or a substituted or non-substituted phenyl group.

Furthermore, R² and R³, each of which is a substituent group on nitrogen in the amidine ligand, may independently be a substituted or non-substituted aryl group or alicyclic group, and particularly, may be a substituted or non-substituted aryl group or alicyclic group of C₅ to C₃₀ , and more particularly, may be a substituted or non-substituted phenyl group. Example of the substituted phenyl group include phenyl groups substituted in the para position, and particularly, phenyl groups substituted in the para position by an alkoxy group of C₁ to C₁₀, an acyl group of C₁ to Cᵤ), or a halogen atom, and particularly phenyl groups substituted in the para position by an alkoxy group of C₁ to Cₛ, or an acyl group of C₁ to C₅, or a halogen atom, etc.

If R² and R³, which are substituent groups on nitrogen in the amidine ligand, are sterically bulky groups, for example, substituted or non-substituted aryl groups or alicyclic groups, and particularly, phenyl groups substituted in the para position, then the amidine ligands may be coordinated at selective positions or may be coordinated only partially (only one or more of the possible positions) so that the amidine ligands are not coordinated adjacent to each other due to the steric hindrance of the substituent groups when the amidine-carboxylic acid complex is synthesized.

R₅ binding amidine ligands to each other in the amidine ligand may be a substituted or non-substituted alkylene group, alkenylene group, alkynylene group, arylene group, aralkylene group or a bivalent alicyclic group of C₁ to C₁₀, for example, alkylene groups of C₂ to C₅, and particularly, alkylene groups of C₃.

For example, the amidine ligand of the amidine-carboxylic acid complex of the invention may be an amidine ligand of n¹=0, namely, a monovalent amidine ligand represented by the following formula:

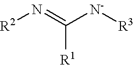

Concrete examples of the monovalent amidine ligand include N,N′-bisphenylformamidine ligand, and its substitution products, for example, N,N′-bis(p-methoxyphenyl)formamidine ligand, N,N′-bis(p-acetylphenyl)formamidine ligand, and N,N′-bis(p-chlorophenyl)formamidine ligand.

Furthermore, for example, the amidine ligand of the amidine-carboxylic acid complex of the invention may be an amidine ligand of n¹=1, namely a bivalent amidine ligand represented by the following formula:

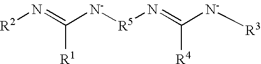

According to this bivalent amidine ligand, an amidine-carboxylic acid ligand can be obtained by substitution with carboxylic acid ligands in a specific positional relationship in accordance with the relative positions of two amidine ligands. According to the amidine-carboxylic acid ligand obtained in this manner, it is possible to relatively reduce the structural isomers of a multiple-complex-containing compound obtained as a product by substituting only carboxylic acids at specific positions in the amidine-carboxylic acid complex by polyvalent carboxylic acid ligands to obtain a multiple-complex-containing compound having an intended configuration.

Concrete examples of the bivalent amidine ligand include 1,3-bis(phenylbenzamidino)propane, and its substitution products, for example, 1,3-bis(p-methoxyphenylbenzamidino)propane.

The metal that serves as a nucleus in the amidine-carboxylic acid complex may be either a main group metal or a transition metal as long as it allows formation of an amidine-carboxylic acid complex. This metal may be particularly a transition metal, and more particularly fourth to eleventh group transition metals, for example, a metal selected from the group consisting of titanium, vanadium, chromium, manganese, iron, cobalt, nickel, zirconium, niobium, molybdenum, technetium, ruthenium, rhodium, palladium, silver, hafnium, tantalum, tungsten, rhenium, osmium, iridium, platinum and gold.

Furthermore, if a catalyst is provided by using a multiple-complex-containing compound made from an amidine-carboxylic acid complex in accordance with the embodiment of the invention, the metal used may be a metal beneficial for the use of the catalyst, for example, the iron group elements (iron, cobalt, nickel), copper, platinum group elements (ruthenium, rhodium, palladium, osmium, iridium, and platinum), gold, silver.

The amidine-carboxylic acid complex of the invention may be a mononuclear complex or a polynuclear complex; for example, it may be a polynuclear complex having 2 to 10 metal atoms, and particularly 2 to 5 metal atoms.

Concrete examples of the amidine-carboxylic acid complex of the invention include amidine-carboxylic acid complexes represented by the following formula:

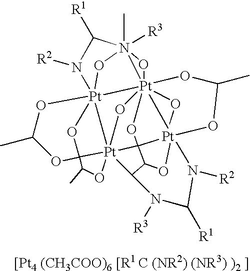

In the formula, R² and R³ independently represent a substituted or non-substituted aryl group or alicyclic group.

In the foregoing formula, R¹ may be hydrogen, or a substituted or non-substituted phenyl group, and particularly may be hydrogen.

According to the amidine-carboxylic acid complex of the foregoing formula, namely, the amidine-carboxylic acid complex in which, of the acetato ligands lying in substantially the same plane as the plane in which the four platinum atoms of octaacetatotetraplatinum lie, two acetato (acetic acid) ligands in the trans position are substituted by amidine ligands, it is possible to align and bind amidine-carboxylic acid complexes in a linear chain form when the carboxylic acid ligands are partially substituted by dicarboxylic acid ligands to obtain a multiple-complex-containing compound.

Concrete examples of other amidine-carboxylic acid complexes of the invention include amidine-carboxylic acid complexes represented by the following formula:

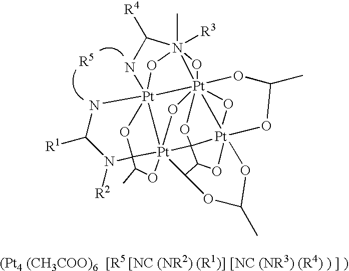

In the formula, R² and R³ independently represent a substituted or non-substituted aryl group or alicyclic group. R₅ represents a substituted or non-substituted alkylene group, alkenylene group or alkynylene group of C₃.

It is to be noted herein that R¹ and R⁴ may be hydrogen, or a substituted or non-substituted phenyl group, and particularly, may be a phenyl group.

According to the amidine-carboxylic acid complex of the foregoing formula, namely, the amidine-carboxylic acid complex in which, of the acetato ligands lying in substantially the same plane as the plane in which the four platinum atoms of octaacetatotetraplatinum lie, two acetato (acetic acid) ligands in the cis position are substituted by amidine ligands, it is possible to two-dimensionally gather and bind amidine-carboxylic acid complexes when the carboxylic acid ligands are partially substituted by dicarboxylic acid ligands to obtain a multiple-complex-containing compound.

In octaacetatotetraplatinum, in addition to the four acetato ligands lying in substantially the same plane as the plane in which the four platinum atoms lie, there lie four acetato ligands coordinated in directions substantially perpendicular to the plane. However, the four acetato ligands coordinated in the directions substantially perpendicular to the plane in which the four platinum atoms lie less likely to contribute to the ligand exchange reaction than the acetato ligands lying in substantially the same plane as the plane in which the four platinum atoms lie.

A method of in accordance with the embodiment of the invention for producing the foregoing amidine-carboxylic acid complex includes (a) providing a carboxylic acid complex made up by coordinating a plurality of carboxylic acid ligands to one metal atom or a plurality of metal atoms of the same element, (b) proving an amidine ligand source, and (c) mixing the carboxylic acid complex and the amidine ligand source in a solvent and therefore substituting the carboxylic acid ligands partially with amidine ligands.

The amidine ligand used in this method in accordance with the embodiment of the invention may be any of the amidine ligands cited above in conjunction with the amidine-carboxylic acid complex.

Namely, for example, the amidine ligand used in this method in accordance with the embodiment of the invention may be a monovalent or polyvalent amidine ligand represented by the following formula.

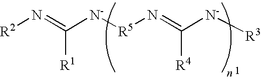

In the formula, R¹ to R⁴ each independently represent hydrogen, or a substituted or non-substituted alkyl group, alkenyl group, alkynyl group, aryl group, alicyclic group, or aralkyl group. R⁵ represents an alkylene group, an alkenylene group, an alkynylene group, an arylene group, an aralkylene group, or a bivalent alicyclic group. n¹ represents an integer of 0 to 5.

If R² and R³, which are substituent groups on nitrogen in this amidine ligand, are sterically bulky groups, for example, substituted or non-substituted aryl groups or alicyclic groups, the amidine ligands may be coordinated at selective positions or may be coordinated only partially (only at one or more of the possible positions) so that the amidine ligands are not coordinated adjacent to each other due to the steric hindrance of the substituent groups when the amidine-carboxylic acid complex is synthesized.

Therefore, in this case, in the step (b), amidine ligands having sterically bulky groups may be supplied in an amount in excess of the amount coordinated to the carboxylic acid complex, and in the step (c), amidine ligands remaining uncoordinated may be removed after the amidine ligand source is mixed with the carboxylic acid complex in the solvent so that amidine ligands are coordinated.

Examples of the carboxylic acid complex provided by the step (a) include arbitrary carboxylic acid complexes. Concrete examples of the carboxylic acid complex include [Pt₄(CH₃COO)₈], [Rh₂(C₆H₅COO)₄], [Rh₂(CH₃COO)₄], [Rh₂(OOCC₆H₄COO)₂], [Cu(C₁₁H₂₃COO)₂]₂, [Cu₂(OOCC₆H₄COO)₂], [Cu₂(OOCC₆H₄CH₃)₄], [Mo₂(OOCC₆H₄COO)₂], [Mo₂(CH₃COO)₄], [N(n-C₄H₉)₄][Fe^{II}Fe^{III}(ox)₃] (“ox” is an oxalic acid ligand), etc.

The multiple-complex-containing compound in accordance with the embodiment of the invention is made up so that a plurality of amidine-carboxylic acid complexes selected from the group consisting of the aforementioned amidine-carboxylic acid complexes and their combinations are bound to each other via polyvalent carboxylic acid ligands substituting at least partially the carboxylic acid ligands. The multiple-complex-containing compound in accordance with the embodiment of the invention may have 2 to 1000 metal atoms, and particularly, 2 to 100 metal atoms, for example, 2 to 50, or 2 to 20, or 2 to 10 metal atoms.

As the polyvalent carboxylic acid ligand in which a plurality of amidine-carboxylic acid complexes are bound to each other, any polyvalent carboxylic acid ligand that can play the aforementioned role may be used. It is preferable that the polyvalent carboxylic acid ligand have a certain length in order to avoid destabilization of a multiple-complex-containing compound due to the steric hindrance between the amidine-carboxylic acid complexes. However, in the case where the multiple-complex-containing compound in accordance with the embodiment of the invention is fired or the like so as to obtain a cluster that has the same number of metal atoms as contained in the multiple-complex-containing compound, the excessive length of the polyvalent ligands may possibly make it difficult to obtain a single kind of cluster from the multiple-complex-containing compound.

This polyvalent carboxylic acid ligand may be a dicarboxylic acid ligand represented by the following formula:

—OOC—R⁷—COO⁻

In the formula, R⁷ represents an alkylene group, an alkenylene group, an alkynylene group, an arylene group, an aralkylene group, or a bivalent alicyclic group. R⁷ may particularly be any of these groups of C₁ to C₃₀, or C₁ to C₂₀, and more particularly may be a substituted or non-substituted linear chain alkylene group or phenylene group such as bi- or tri-phenylene which are of C₅ to C₁₅.

Concrete examples of the multiple-complex-containing compound of the invention include multiple-complex-containing compounds represented by the following formula:

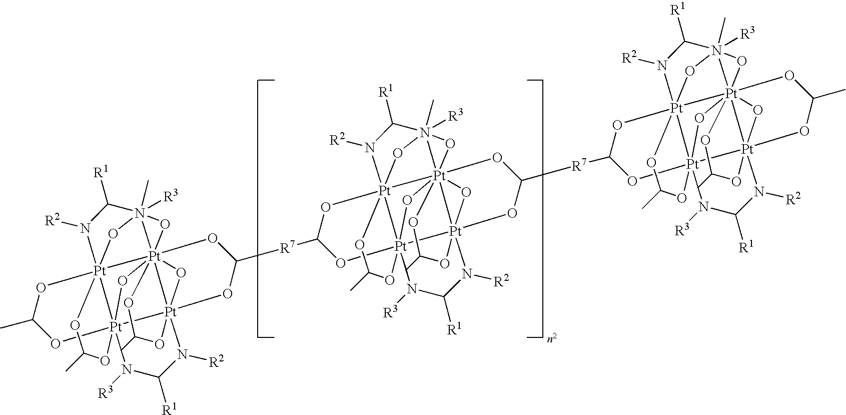

In the formula, n² represents an integer of 0 to 50, and particularly an integer of 1 to 10, and more particularly an integer of 1 to 5. It is to be noted herein that R⁷ may particularly be a substituted or non-substituted linear chain alkylene group of C₅ to C₁₅.

Furthermore, concrete examples of other multiple-complex-containing compounds in accordance with the embodiment of the invention include multiple-complex-containing compounds represented by the following formula:

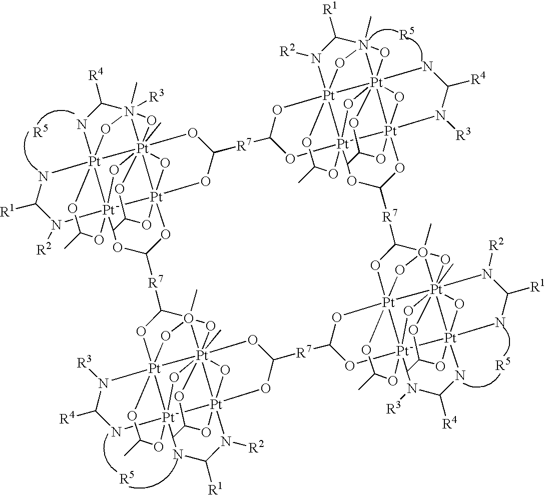

In this formula, R₇ may be a phenylene group, or a polyphenylene group such as bi- or tri-phenylene.

The method for producing a multiple-complex-containing compound in accordance with the embodiment of the invention includes: (a) providing an amidine-carboxylic acid complex selected from the group consisting of the aforementioned amidine-carboxylic acid complexes and their combinations, (b) providing a polyvalent carboxylic acid ligand source and, particularly, a dicarboxylic acid ligand source, and (c) mixing the amidine-carboxylic acid complex and the polyvalent carboxylic acid ligand source in a solvent and therefore substituting the carboxylic acid ligands of the amidine-carboxylic acid complex at least partially with polyvalent carboxylic acid ligands.

The polyvalent carboxylic acid ligand source used in this method may be used in relatively large amount in order to facilitate the substitution of carboxylic acid ligands of the amidine-carboxylic acid complex with the polyvalent carboxylic acid ligands. However, it is generally preferable that the amount of the polyvalent carboxylic acid ligand source used in this method be less than the amount thereof needed in order to entirely substitute the carboxylic acid ligands coordinated in the amidine-carboxylic acid complex, in order that a controlled number of amidine-carboxylic acid complexes be bound to each other.

Examples of the polyvalent carboxylic acid ligand source used herein include the polyvalent carboxylic acid ligand source mentioned above with regard to the multiple-complex-containing compound.

The method for producing a metal or metal oxide cluster in accordance with the embodiment of the invention includes (a) providing a solution that contains a multiple-complex-containing compound as mentioned above, and (b) removing a ligand of the multiple-complex-containing compound.

The removal of the ligand of the multiple-complex-containing compound is accomplished by drying or firing the solution that contains the multiple-complex-containing compound. The drying and the firing may be performed, for example, in a condition of a temperature and a time that are sufficient to obtain metal or metal oxide clusters. For example, the drying may be performed at a temperature of 120 to 250° C. for 1 to 2 hours, and the firing may be performed at a temperature of 400 to 600° C. for 1 to 3 hours. As the solvent of the solution used in this method, it is possible to use any solvent capable of stably maintaining the multiple-complex-containing compound in accordance with the embodiment of the invention, for example, an aqueous solvent, or an organic solvent such as dichloroethane, or the like.

This method may further include impregnating a porous support with the solution before removing the ligand of the multiple-complex-containing compound in the step (b).

In the case where a catalyst, particularly, an exhaust gas purification catalyst, is to be produced by using this method, the porous support used in the case may be a porous metal oxide support, for example, a porous metal oxide support selected from the group consisting of alumina, ceria, zirconia, silica, titania, and their combinations.

Hereinafter, the invention will be described with reference to examples. The invention is not limited to the examples below.

The analyses in the examples were performed through the use of measurement instruments shown below. VARIAN-MERCURY 300-C/H (VARIAN Company) was used for the NMR analysis. JASCO FT/IR 230 (JASCO Company) was used for the IR analysis. JEOL SX-203 (JEOL Company) was used for the MASS spectrometry. Parkin-Elmer 2400 (Parkin-Elmer Company) was used for the elemental analysis. RAXIS-RAPID (Rigaku Company) was used for the X-ray single crystal structure analyses.

### Example 1

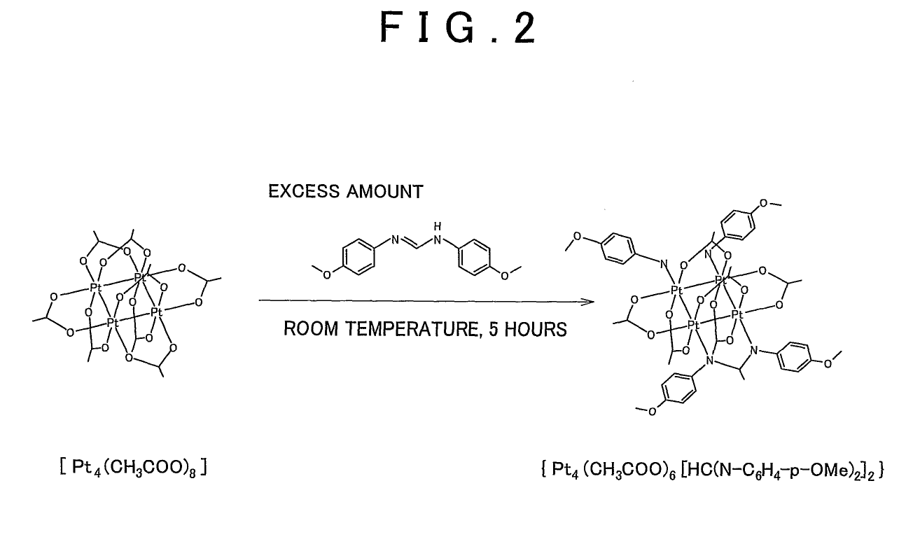

The synthesis of a trans-2-substituted complex of octaacetatotetraplatinum {Pt₄(CH₃COO)₆[(HC(N—C₆H₄-p-OMe)₂]₂} was performed in a scheme shown in FIG. 2.

Octaacetatotetraplatinum [Pt₄(CH₃COO)₈] (0.423 g, 0.337 mmol) and N,N′-bis(p-methoxyphenyl)formamidine (also called “N,N′-di(p-anisyl)formamidine”) (0.858 g, 3.35 mmol, 9.9 equivalent weight) were placed in a Schlenk flask, and were dissolved in dichloromethane (CH₂Cl₂) (15 mL) to obtain a red solution, which turned into a dark red solution in about 30 min. After the solution was stirred at room temperature for 5 hours, the solvent was removed by evaporation under reduced pressure, and the remaining substance was washed with diethylether (20 mL×3). As a result, a dark red solid was obtained (yield amount=0.484 g, yield percentage=87%).

Spectral data and elemental analysis results of the product: ¹H NMR (300 MHz, CDCl₃, 308 K): δ 1.85 (s, 6H, ^{ax}O₂CCH₃), 1.91 (s, 6H, ^{ax}O₂CCH₃), 2.16 (s, 6H, ^{eq}O₂CCH₃), 3.81 (s, 12H, OCH₃), 6.81 (s, 2H, —NCHN—), 6.87 (d, ³J_{H—H}=8.7 Hz, 8H, Ar—H), 7.24 (d, ³J_{H—H}=8.7 Hz, 8H, Ar—H).

¹³C NMR (75 MHz, CDCl₃, 308 K): δ 21.3, 21.8, 22.8 (q, ¹J_{C—H}=130.2 Hz, O₂CCH₃), 55.5 (q, ¹J_{C—H}=143.2 Hz, OCH₃), 113.8 (dd, ¹J_{C—H}=157.5 Hz, ³J_{C—H}=5.5 Hz, o or m-Ar—C), 125.2 (dd, ¹J_{C—H}=159.2 Hz, ³J_{C—H}=6.0 Hz, o or m-Ar—C), 142.9, 156.2 (s, p or ipso-Ar—C), 161.5 (d, ¹J_{C—H}=170.5 Hz, —NCHN—), 186.0, 191.3, 193.8 (s, O₂CCH₃).

MS (ESI+, CH₃CN solution): m/z 1645 ([M+H]⁺).

IR (KBr disk, ν/cm⁻¹): 3034, 2994, 2937, 2833, 1610, 1572, 1502, 1409, 1342, 1290, 1217, 1177, 1107, 1035, 973, 941, 830, 789, 757, 726, 683, 643.

Anal. Calcd. for C₄₃H₄₉Cl₃N₄O₁₆Pt₄: C, 29.27; H, 2.80; N, 3.18. Found: C, 29.10; H, 3.04; N, 3.01.

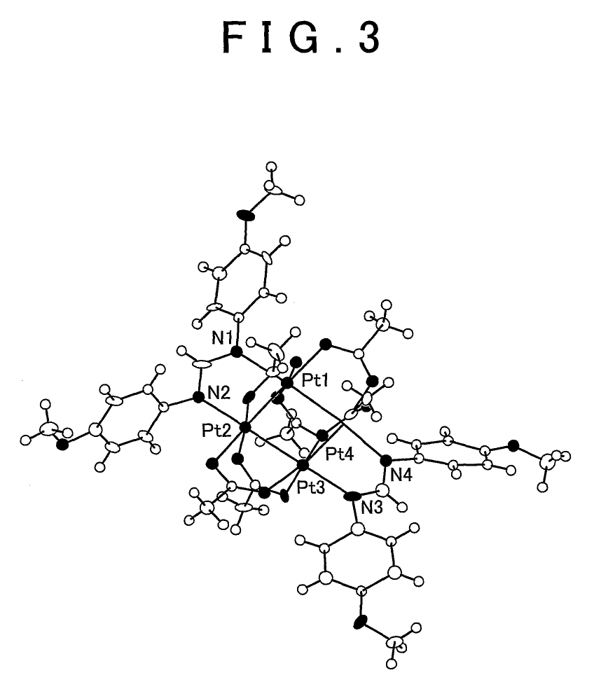

The X-ray single crystal structure of the product is shown in FIG. 3.

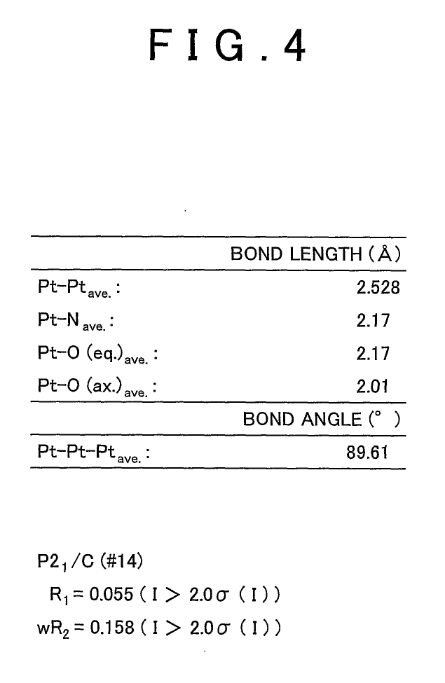

Furthermore, analysis results regarding the crystal structure are shown in FIG. 4.

### Example 2

Instead of N,N′-bis(1)-methoxyphenyl)formamidine in Example 1, N,N′-bis(p-acetylphenyl)formamidine as shown below was used to perform the synthesis.

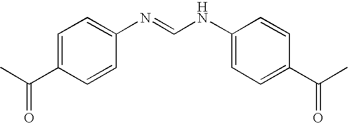

Octaacetatotetraplatinum [Pt₄(CH₃COO)₈] (0.311 g, 0.248 mmol) and N,N′-bis(p-acetylphenyl)formamidine (0.697 g, 2.49 mmol, 10 equivalent weight) were placed in a Schlenk flask, and were dissolved in a mixed solved of CH₂Cl₂ (10 mL) and methanol (MeOH) (5 mL) to obtain a red solution, which turned into a deep red solution in about 30 min. After the solution was stirred at room temperature for 5 hours, the solvent was removed by evaporation under reduced pressure, and the remaining substance was washed with MeOH (20 mL×3). As a result, an orange-red solid was obtained (yield amount=0.354 g, yield percentage=84%).

Spectral data and elemental analysis results of the product: ¹H NMR (300 MHz, CDCl₃, 308 K): d 1.90 (s, 6H, ^{ax}O₂CCH₃), 1.93 (s, 6H, ^{ax}O₂CCH₃), 2.20 (s, 6H, ^{eq}O₂CCH₃), 2.60 (s, 12H, —COCH₃), 7.07 (s, 2H, —NCHN—), 7.41 (d, ³J_{H—H}=9.0 Hz, 8H, Ar—H), 7.97 (d, ³J_{H—H}=9.0 Hz, 8H, Ar—H).

¹³C NMR (75 MHz, CDCl₃, 308 K): d 21.3 (q, ¹J_{C—H}=130.7 Hz, ^{ax}O₂CCH₃), 21.7 (q, ¹J_{C—H}=125.9 Hz, ^{ax}O₂CCH₃), 22.9 (q, ¹J_{C—H}=129.0 Hz, ^{eq}O₂CCH₃), 26.5 (q, ¹J_{C—H}=127.3 Hz, —OCCH₃), 124.0 (dd, ¹J_{C—H}=161.8 Hz, ³J_{C—H}=5.2 Hz, o or m-Ar—C), 129.2 (dd, ¹J_{C—H}=160.1 Hz, ³J_{C—H}=6.9 Hz, o or m-Ar—C), 132.9 (t, ³J_{C—H}=7.2 Hz, p-Ar—C), 153.2 (s, ipso-Ar—C), 162.3 (d, ¹J_{C—H}=172.2 Hz, —NCHN—), 186.5, 192.1, 194.1 (s, O₂CCH₃), 196.9 (s, —COCH₃).

MS (ESI+, CH₃CN solution): m/z 1693 ([M+H]⁺).

IR(KBr disk, n/cm⁻¹): 3000, 2936, 1675, 1595, 1557, 1532, 1502, 1412, 1346, 1304, 1270, 1223, 1177, 1117, 1075, 1042, 1012, 957, 840, 728, 685, 640, 621.

Anal. Calcd. for C₄₆H₄₈N₄O₁₆Pt₄: C, 32.63; H, 2.86; N, 3.31. Found: C, 32.69; H, 2.97; N, 3.18.

### Example 3

Instead of N,N′-bis(p-methoxyphenyl)formamidine in Example 1, N,N′-bis(p-chlorophenyl)formamidine shown below was used to perform the synthesis.

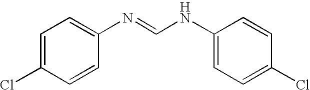

Octaacetatotetraplatinum [Pt₄(CH₃COO)₈] (0.409 g, 0.326 mmol) and N,N′-bis(p-chlorophenyl)formamidine (0.883 g, 3.33 mmol, 10 equivalent weight) were placed in a Schlenk flask, and were dissolved in a mixed solvent of CH₂Cl₂ (10 mL) and MeOH (5 mL), so as to obtain a red solution, which turned into a deep red solution in about 30 min. After the solution was stirred at room temperature for 8 hours, the solvent was removed by evaporation under reduced pressure, and the remaining substance was washed with MeOH (20 mL×3). As a result, a dark red solid was obtained (yield amount=0.252 g, yield percentage=46%).

Spectral data of the product: ¹H NMR (300 MHz, CDCl₃, 308 K): d 1.87 (s, 6H, ^{ax}O₂CCH₃), 1.91 (s, 6H, ^{ax}O₂CCH₃), 2.17 (s, 6H, ^{eq}O₂CCH₃), 6.85 (s, 2H, —NCHN—), 7.23 (d, ³J_{H—H}=9.3 Hz, 8H, Ar—H), 7.28 (d, ³J_{H—H}=9.3 Hz, 8H, Ar—H).

¹³C NMR (75 MHz, CDCl₃, 308 K): d 21.3 (q, ¹J_{C—H}=130.2 Hz, ^{ax}O₂CCH₃), 21.7 (q, ¹J_{C—H}=130.2 Hz, ^{ax}O₂CCH₃), 22.9 (q, ¹J_{C—H}=129.0 Hz, ^{eq}O₂CCH₃), 125.6 (dd, ¹J_{C—H}=162.4 Hz, ³J_{C—H}=5.2 Hz, o or m-Ar—C), 128.5 (dd, ¹J_{C—H}=164.7 Hz, ³J_{C—H}=5.2 Hz, o or m-Ar—C), 129.1 (t, ³J_{C—H}=9.5 Hz, p-Ar—C), 147.5 (s, ipso-Ar—C), 161.9 (d, 1J_{C—H}=171.6 Hz, —NCHN—), 186.3, 191.7, 194.0 (s, O₂CCH₃).

MS (ESI+, CH₃CN solution): m/z 1586 ([M−OAc+CH₃CN+H]⁺).

IR(KBr disk, n/cm⁻¹): 3027, 2971, 2937, 2858, 1602, 1566, 1486, 1412, 1341, 1219, 1087, 1042, 1011, 977, 939, 844, 830, 726, 708, 685, 634, 605.

### Example 4

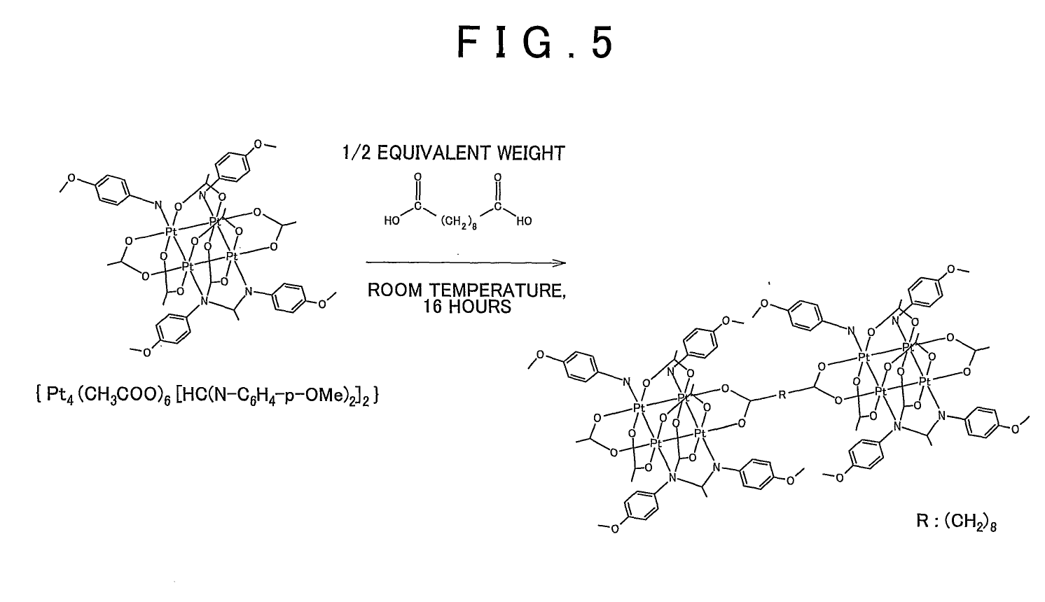

The synthesis of a dimer (platinum (Pt) 8-nuclear complex) from a trans-2-substituted complex of octaacetatotetraplatinum was performed in a scheme shown in FIG. 5.

The trans-2-substituted complex {Pt₄(CH₃COO)₆[HC(N—C₆H₄-p-OMe)₂]₂} (0.498 g, 0.303 mmol) obtained as in Example 1 was placed in a Schlenk flask, and was dissolved in a mixed solvent of CH₂Cl₂ (20 mL) and MeOH (8 mL) to obtain a dark red solution. 3.05 mL of a solution (30.6 mg, 0.151 mmol, 0.50 equivalent weight) obtained by dissolving 0.201 g of sebacic acid (0.992 mmol) in MeOH so as to make up a volume of 20.0 mL was added into the Schlenk flask. After the solution was stirred at room temperature for 16 hours, the solvent was removed by evaporation under reduced pressure, and the remaining substance was washed with diethylether (20 mL×2). As a result, a dark red solid was obtained (yield amount=0.481 g).

Spectral data of the product: ¹H NMR (300 MHz, CDCl₃, 308 K) δ: 1.20-1.31 (m, —CH₂—), 1.52-1.64 (m, —CH₂—), 1.80-1.95 (m, —CH₂—), 1.84, 1.85, 1.89, 1.90, 1.91 (s, —CH₃), 2.16 (s, —CH₃), 2.35-2.45 (m, —CH₂—), 3.77, 3.80 (s, —OCH₃), 6.82 (s, —NCHN—), 6.82-6.89 (m, ArH), 7.20-7.26 (m, ArH).

¹³C {¹H} NMR (75 MHz, CDCl₃, 308 K) δ: 21.3, 21.8, 26.1, 29.2, 29.7, 36.3 (methyl or methylene C), 55.5 (—OCH₃), 113.7, 113.8, 125.2, 125.3, 142.9, 156.0 (Ar—C), 161.4 (—NCHN—), 186.0, 188.5, 191.3, 193.7 (—O₂C—).

IR(KBr disk, ν/cm⁻¹): 2932, 2833, 1610, 1573, 1502, 1439, 1406, 1341, 1291, 1243, 1217, 1177, 1106, 1035, 972, 830, 789, 756, 726, 685, 646.

### Example 5

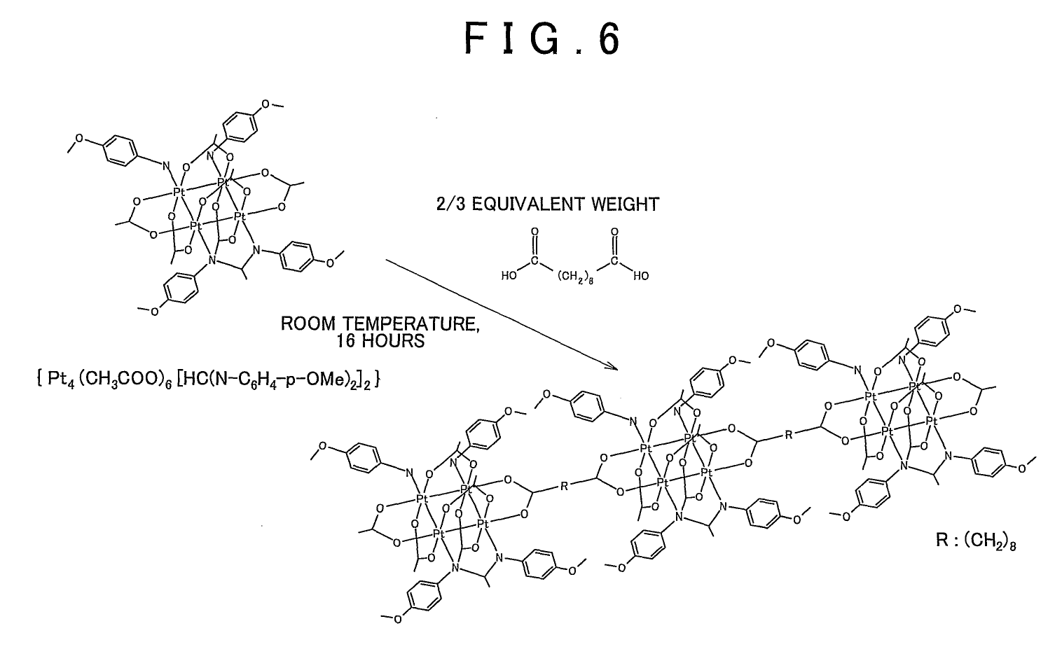

The synthesis of a trimer (platinum 12-nuclear complex) from a trans-2-substituted complex of octaacetatotetraplatinum was performed in a scheme shown in FIG. 6.

The trans-2-substituted complex {Pt₄(CH₃COO)₆[HC(N—C₆H₄-p-OMe)₂]₂} (0.495 g, 0.301 mmol) obtained as in Example 1 was placed in a Schlenk flask, and was dissolved in a mixed solvent of CH₂Cl₂ (20 mL) and MeOH (8 mL) to obtain a dark red solution. 4.05 mL of a solution (40.6 mg, 0.201 mmol, 0.67 equivalent weight) obtained by dissolving 0.201 g of sebacic acid (0.992 mmol) in MeOH so as to make up a volume of 20.0 mL was added into the Schlenk flask. After the solution was stirred at room temperature for 16 hours, the solvent was removed by evaporation under reduced pressure, and the remaining substance was washed with diethylether (20 mL×2). As a result, a dark red solid was obtained (yield amount=0.473 g).

Spectral data of the product: ¹H NMR (300 MHz, CDCl₃, 308 K) δ: 1.18-1.35 (m, —CH₂—), 1.52-1.64 (m, —CH₂—), 1.80-1.95 (m, —CH₂—), 1.84, 1.85, 1.89, 1.90, 1.91 (s, —CH₃), 2.16 (s, —CH₃), 2.35-2.45 (m, —CH₂—), 3.77, 3.81 (s, —OCH₃), 6.83 (s, —NCHN—), 6.84-6.89 (m, ArH), 7.20-7.26 (m, ArH).

IR(KBr disk, ν/cm⁻¹): 3035, 2996, 2932, 2834, 1610, 1573, 1502, 1439, 1405, 1342, 1291, 1243, 1217, 1177, 1106, 1035, 971, 830, 790, 757, 726, 685, 643.

### Example 6

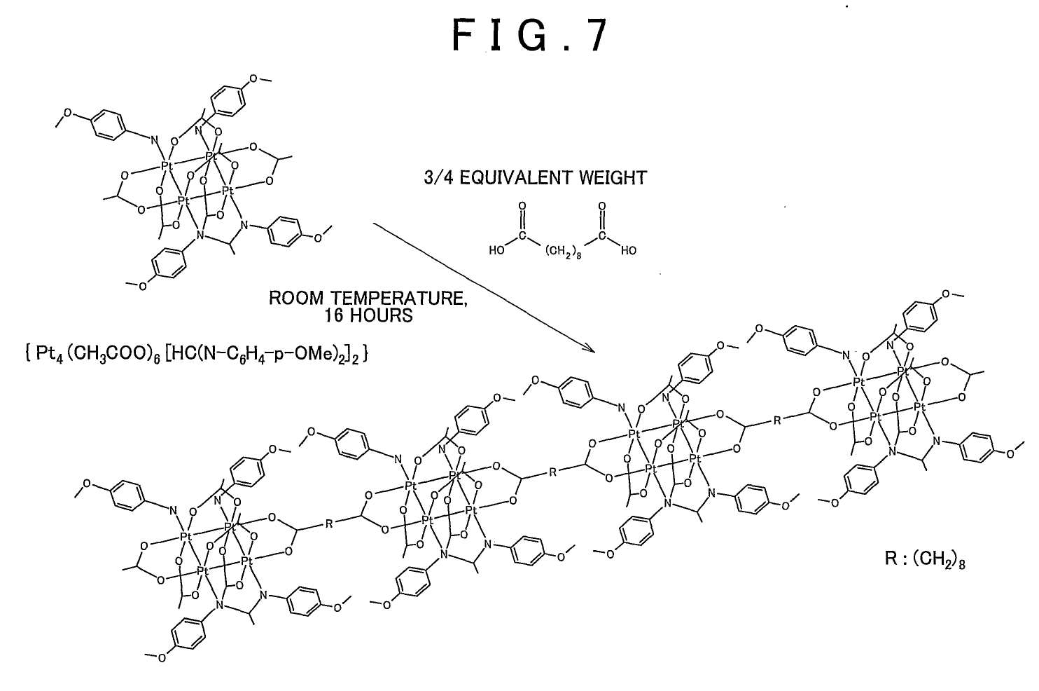

The synthesis of a tetramer (platinum 16-nuclear complex) from a trans-2-substituted complex of octaacetatotetraplatinum was performed in a scheme shown in FIG. 7.

The trans-2-substituted complex {Pt₄(CH₃COO)₆[HC(N—C₆H₄-p-OMe)₂]₂} (0.502 g, 0.305 mmol) obtained as in Example 1 was placed in a Schlenk flask, and was dissolved in a mixed solvent of CH₂Cl₂ (20 mL) and MeOH (8 mL) to obtain a dark red solution. 3.06 mL of a solution (46.2 mg, 0.228 mmol, 0.75 equivalent weight) obtained by dissolving 0.302 g of sebacic acid (1.49 mmol) in MeOH so as to make up a volume of 20.0 mL was added into the Schlenk flask. After the solution was stirred at room temperature for 16 hours, the solvent was removed by evaporation under reduced pressure, and the remaining substance was washed with diethylether (20 mL×2). As a result, a dark red solid was obtained (yield amount=0.487 g).

Spectral data of the product: ¹H NMR (300 MHz, CDCl₃, 308 K) δ: 1.17-1.35 (m, —CH₂—), 1.52-1.70 (m, —CH₂—), 1.80-1.95 (m, —CH₂—), 1.84, 1.89, 1.92 (s, —CH₃), 2.16 (s, —CH₁₃), 2.35-2.45 (m, —CH₂—), 3.77, 3.80 (s, —OCH₃), 6.82 (s, —NCHN—), 6.82-6.89 (m, ArH), 7.20-7.26 (m, ArH).

¹³C {¹H} NMR (75 MHz, CDCl₃, 308 K) δ: 21.3, 21.7, 21.8, 26.1, 29.2, 29.7, 36.3 (methyl or methylene C), 55.5 (—OCH₃), 113.7, 113.8, 125.2, 125.3, 142.9, 156.0 (Ar—C), 161.4 (—NCHN—), 186.0, 188.5, 191.3, 193.7 (—O₂C—).

IR(KBr disk, ν/cm⁻¹): 3033, 2993, 2931, 2833, 1610, 1573, 1501, 1438, 1403, 1340, 1290, 1242, 1216, 1176, 1105, 1034, 972, 941, 829, 789, 756, 726, 685, 644, 610, 592, 538, 406.

### Example 7

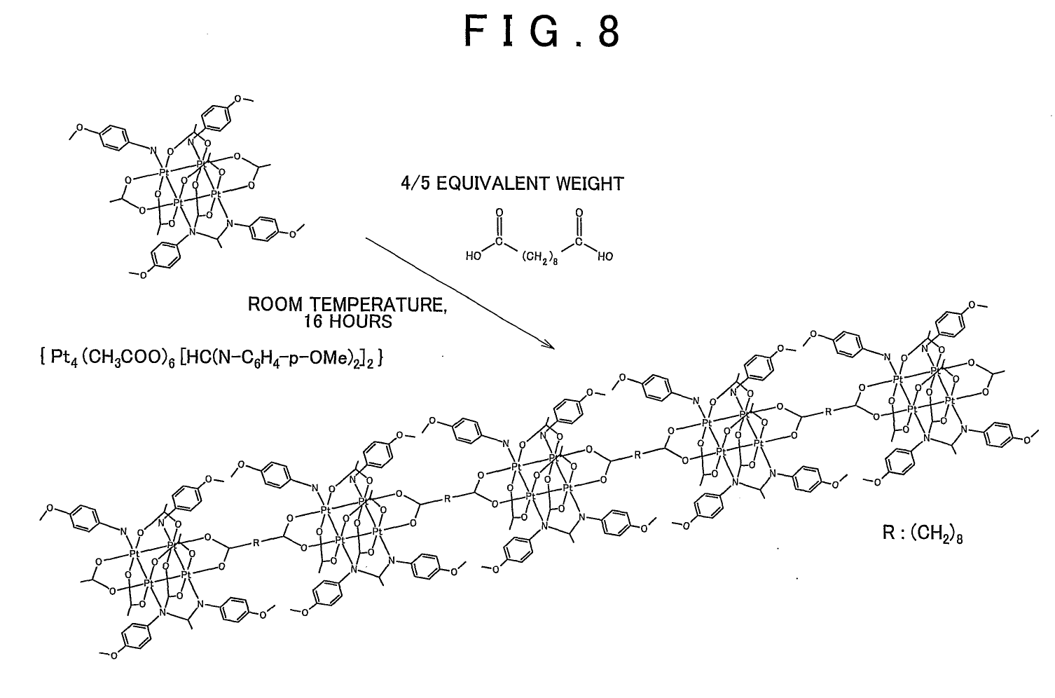

The synthesis of a pentamer (platinum 20-nuclear complex) from a trans-2-substituted complex of octaacetatotetraplatinum was performed in a scheme shown in FIG. 8.

The trans-2-substituted complex {Pt₄(CH₃COO)₆[HC(N—C₆H₄-p-OMe)₂]₂} (0.496 g, 0.301 mmol) obtained as in Example 1 was placed in a Schlenk flask, and was dissolved in a mixed solved of CH₂Cl₂ (20 mL) and MeOH (8 mL) to obtain a dark red solution. 3.24 mL of a solution (48.9 mg, 0.242 mmol, 0.8 equivalent weight) obtained by dissolving 0.302 g of sebacic acid (1.49 mmol) in MeOH so as to make up a volume of 20.0 mL was added into the Schlenk flask. After the solution was stirred at room temperature for 16 hours, the solvent was removed by evaporation under reduced pressure, and the remaining substance was washed with diethylether (20 mL×2). As a result, a dark red solid was obtained (yield amount=0.462 g).

Spectral data of the product: ¹H NMR (300 MHz, CDCl₃, 308 K) δ: 1.17-1.31 (m, —CH₂—), 1.52-1.64 (m, —CH₂—), 1.80-1.95 (m, —CH₂—), 1.84, 1.85, 1.89, 1.90, 1.91 (s, —CH₃), 2.16 (s, —CH₃), 2.35-2.45 (m, —CH₂—), 3.77, 3.80 (s, —OCH₃), 6.82 (s, —NCHN—), 6.82-6.89 (m, ArH), 7.20-7.26 (m, ArH).

ER(KBr disk, ν/cm⁻¹): 3034, 2993, 2929, 2833, 1610, 1573, 1502, 1455, 1438, 1402, 1339, 1291, 1243, 1216, 1176, 1106, 1034, 972, 942, 829, 789, 757, 726, 685, 644, 611, 592, 537, 425, 408.

### Example 8

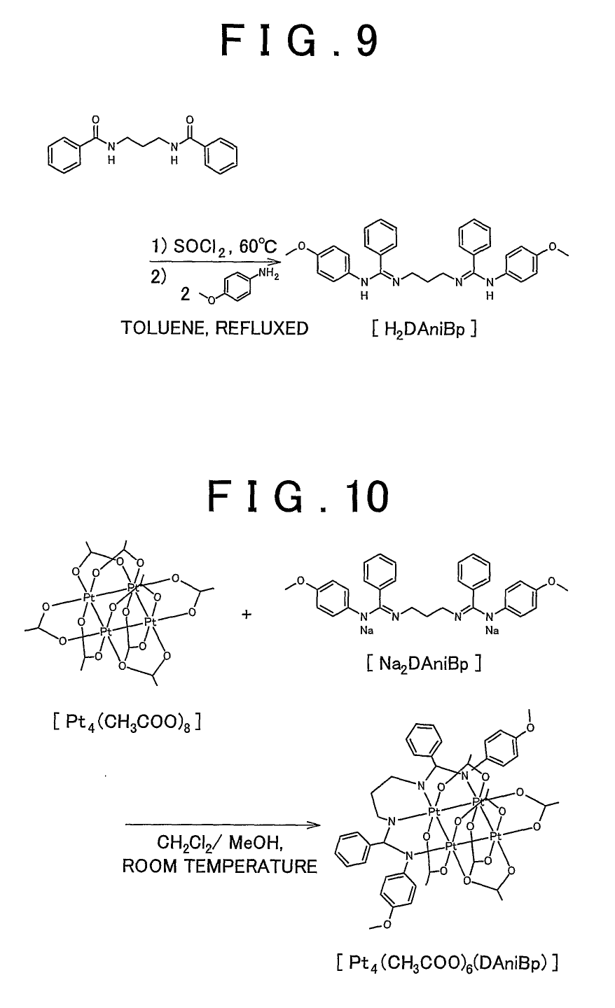

The synthesis of bidentate ligand {1,3-bis(p-methoxyphenylbenzamidino)propane}(H₂DAniBp) for cis-2-substitution was performed in a scheme shown in FIG. 9.

Diamide (6.99 g, 0.0248 mol) and thionyl chloride (SOCl₂) (9.0 mL, 15 g, 0.12 mol, 5.0 equivalent weight) were placed in a 50-mL eggplant flask, and the obtained mixed was warmed in a water bath (60° C.) to obtain a yellow solution. During this reaction was the production of hydrogen chloride (HCl) was confirmed by using a pH test paper. After the solution was heated for 5 hours, excess SOCl₂ was removed under reduced pressure, so that a yellow oil-like substance appeared. CH₂Cl₂ was then added to the oil-like substance to perform reprecipitation, so that a white solid appeared. Then, p-anisidine (5.70 g, 0.0463 mol, 1.9 equivalent weight) and toluene (20 mL) were added to the white solid, so that a yellow suspension formed. After being refluxed for 5 hours, the reaction solution was cooled. Then, the solution was combined with CH₂Cl₂ and water, and was transferred to a reparatory funnel, in which the CH₂Cl₂ layer was washed with a sodium carbonate (Na₂CO₃) aqueous solution. After the washed mixture was dried with magnesium sulfate (MgSO₄), the solvent was removed through the use of an evaporator, so that a red-brown solid appeared. The solid was recrystallized from a toluene-ethanol mixture solvent (5 to 10% of ethanol) in a temperature gradient to obtain a white solid (yield amount=1.15 g, melting point=218.0 to 220.5° C.).

Spectral data and elemental analysis results of the product: ¹H NMR (300 MHz, CDCl₃, 308 K): δ 2.45-2.62 (brm, 2H, —CH₂CH₂CH₂—), 3.70 (s, 6H, —OCH₃), 4.10-4.25 (brm, 4H, ═NCH₂—), 6.64 (d, ³J_{HH}=8.7 Hz, 4H, Ar—H of Ani), 6.94 (d, ³J_{HH}=8.7 Hz, 4H, Ar—H of Ani), 7.25-7.31 (m, 4H, Ar—H of Ph), 7.38-7.46 (m, 6H, Ar—H of Ph).

¹³C{¹H}NMR (75 MHz, CDCl₃, 308 K): d 27.1 (—CH₂CH₂CH₂—), 42.2 (═NCH₂—), 55.4 (—OCH₃), 114.1, 126.8, 127.9, 128.6, 129.5, 129.7, 132.2, 157.9 (Ar—C), 162.0 (—NHCPhN—).

IR(KBr disk, /cm⁻¹): ν3440 (br, N—H), 2997 (brm, C—H), 2835 (brm, C—H), 1633 (s, C═N), 1512, 1444, 1367, 1297, 1246, 1177, 1109, 1031, 836, 784, 742, 699.

MS (FAB+): m/z 493 ([M+H]⁺), 210 ([MeOC₆H₄NCPh]⁺).

HR-MS (FAB+): calcd. for C₃₁H₃₃N₄O₂ (M+H): 493.2604; found: 493.2619.

### Example 9

The synthesis of a cis-2-substituted complex of 9 octaacetatotetraplatinum was performed in a scheme shown in FIG. 10.

Sodium methoxide (MeONa) (16 mg, 0.30 mmol, 3 equivalent weight), and 1,3-bis(p-methoxyphenylbenzamidino)propane(H₂DAniBp) (74 mg, 0.15 mmol, 1.5 equivalent weight) obtained in Example 8 were weighed and placed into a Schlenk flask, and methanol (2 mL) was added to dissolve them. Thus, a pale yellow solution was obtained. After the solution was stirred at room temperature for 1 hour, the solvent was removed by evaporation under reduced pressure. Then, octaacetatotetraplatinum [Pt₄(CH₃COO)₈] (0.126 g, 0.101 mmol), CH₂Cl₂ (6 mL), and MeOH (3 mL) were added to obtain a deep red suspension. After the suspension was stirred at room temperature for 19 hours, the solvent was removed by evaporation under reduced pressure. The precipitated red solid was dissolved in CH₂Cl₂, and was filtered. The filtrate was dried under reduced pressure, and washed with diethylether (10 mL×3). Thus, a red-orange solid was obtained (yield amount=0.156 g, yield percentage=95%, melting point=226 to 229° C.).

Spectral data and elemental analysis results of the product: ¹H NMR (300 MHz, CDCl₃, 308 K): δ 1.75-1.85 (m, 2H, —CH₂CH₂CH₂—), 1.79 (s, 6H, ^{ax}O₂CCH₃), 2.04 (s, 6H, ^{ax}O₂CCH₃), 2.21 (s, 6H, ^{eq}O₂CCH₃), 2.90-3.10 (m, 4H, ═NCH₂—), 3.66 (s, 6H, —OCH₃), 6.57 (d, ³J_{HH}=8.7 Hz, 4H, Ar—H of Ani), 6.86 (d, ³J_{HH}=8.7 Hz, 41-1, Ar—H of Ani), 7.00-7.12 (m, 2H, Ar—H of Ph), 7.15-7.30 (m, 8H, Ar—H of Ph).

¹³C NMR (75 MHz, CDCl₃, 308 K): δ 21.5 (q, ¹J_{CH}=130.1 Hz, ^{ax}O₂CCH₃), 21.6 (q, ¹J_{CH}=129.9 Hz, ^{ax}O₂CCH₃), 23.2 (q, ¹J_{CH}=130.1 Hz, ^{eq}O₂CCH₃), 32.9 (t, ¹J_{CH}=124.1 Hz, —CH₂CH₂CH₂—), 51.1 (t, ¹J_{CH}=135.9 Hz, ═NCH₂—), 55.1 (q, ¹J_{CH}=143.0 HZ, —OCH₃), 112.8 (dd, ¹J_{CH}=156.7 Hz, ²J_{CH}=4.6 Hz, Ar—C of Ani), 127.6₇ (d, ¹J_{CH}=160.7 Hz, Ar—C of Ph), 127.7₄ (d, ¹J_{CH}=160.7 Hz, Ar—C of Ph), 127.8 (d, ¹J_{CH}=160.1 Hz, Ar—C of Ph), 128.1 (d, ¹J_{CH}=160.7 Hz, Ar—C of Ph), 128.4 (d, ¹J_{CH}=160.7 Hz, Ar—C of Ph), 129.1 (dd, ¹J_{CH}=157.5 Hz, ²J_{CH}=6.0 Hz, Ar—C of Ani), 134.4 (s, Ar—C), 141.0 (s, Ar—C), 155.3 (s, Ar—C), 172.4 (s, —NCPhN—), 182.3 (s, ^{eq}O₂CCH₃), 191.6 (s, ^{ax}O₂CCH₃), 191.9 (s, ^{ax}O₂CCH₃).

IR (KBr disk, /cm⁻¹): ν, 2944 (C—H), 2905 (C—H), 2834 (C—H), 1560 (s, CO₂), 1505, 1430, 1402, 1362, 1340, 1289, 1239, 1168, 1142, 1029, 847, 724, 705, 676, 599.

MS (ESI+, CH₃CN solution): m/z 1747 ([M+3 sol.]⁺), 1565 ([M—OAc]⁺).

Anal. Calcd. for C₄₃H₄₈N₄O₁₄Pt₄.3 (CHCl₃): C, 27.86; H, 2.59; N, 2.82. Found: C, 28.21; H, 2.87; N, 2.81.

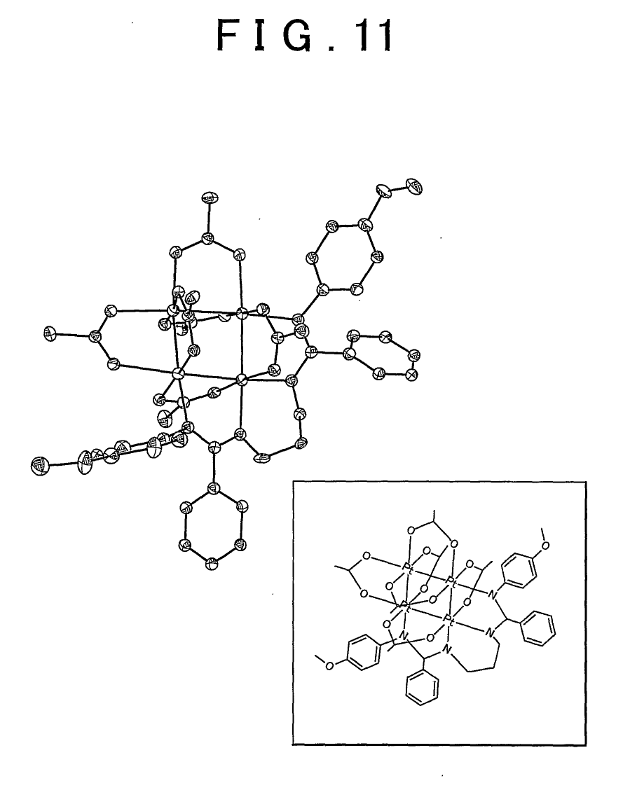

FIG. 11 shows the X-ray single crystal structure of the product.

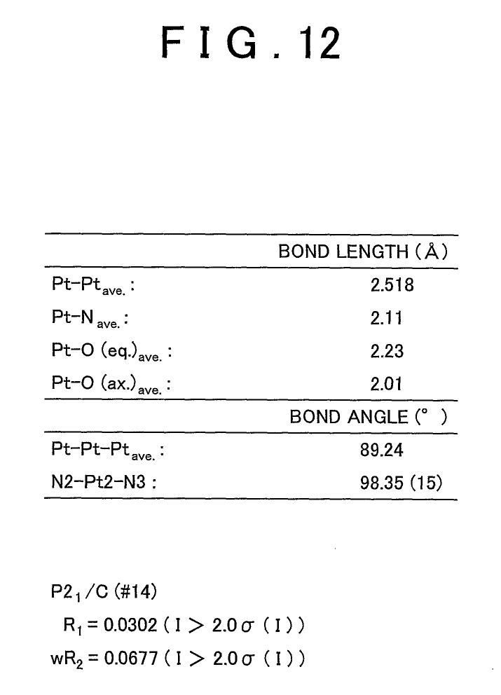

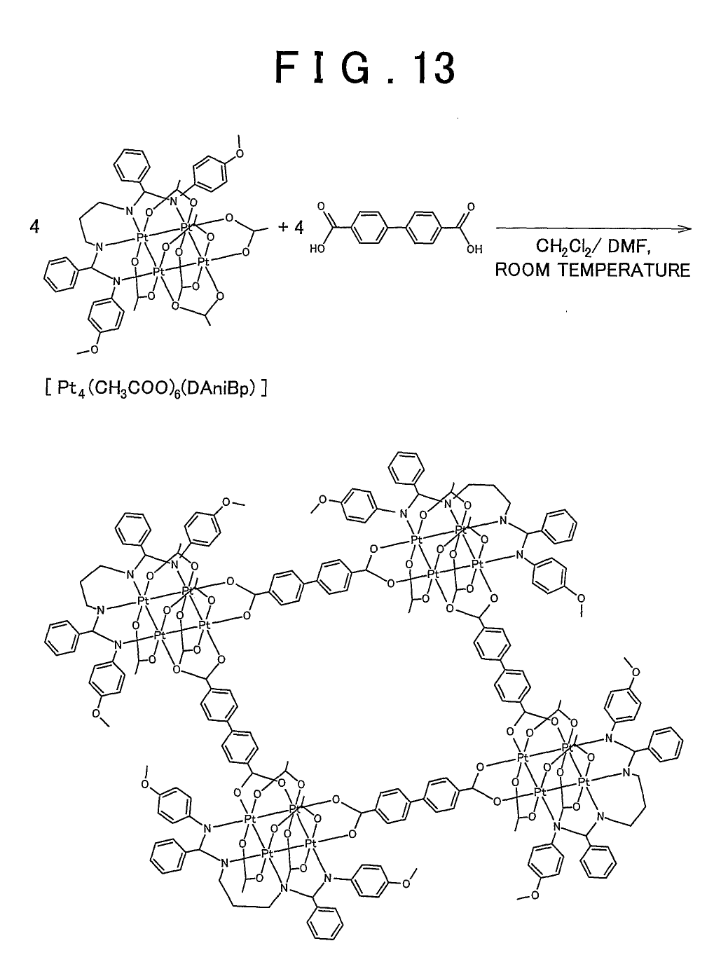

FIG. 12 results of the X-ray diffraction analysis regarding the crystal structure.

### Example 10

The synthesis of a tetramer (platinum (Pt) 16-nuclear complex) from a cis-2-substituted complex of octaacetatotetraplatinum was performed in a scheme shown in FIG. 13.

A cis-2-substituted complex {Pt₄(CH₃COO)₆(DAniBp)} (72 mg, 44 mmol) as obtained in Example 9, and 4,4′-biphenyldicarboxylic acid (11 mg, 45 mmol, 1.0 equivalent weight) were placed into a Schlenk flask, and were dissolved in CH₂Cl₂ (3 mL) and dimethylformamide (DMF) (7 mL) to obtain a deep red solution, which turned into a red suspension in about 2 hours. After the suspension was stirred at room temperature for 14 hours, the solvent was removed by evaporation under reduced pressure, and the remaining substance was washed with diethylether (8 mL×3). Thus, a red-orange solid was obtained (yield amount=68 mg, yield percentage=88%).

Spectral data of the product: ¹H NMR (300 MHz, CDCl₃, 308 K): δ 1.81 (s, 24H, ^{ax}O₂CCH₃), 2.10 (s, 24H, ^{ax}O₂CCH₃), 1.80-1.90 (m, 8H, —CH₂CH₂CH₂—), 3.00-3.20 (m, 16H, ═NCH₂—), 3.82 (s, 6H, —OCH₃), 6.74 (d, ³J_{HH}=8.9 Hz, 16H, Ar—H of Ani), 6.99 (d, ³J_{HH}=8.9 Hz, 16H, Ar—H of Ani), 7.10-7.15 (m, 8H, Ar—H of Ph), 7.20-7.30 (m, 12H, Ar—H of Ph), 7.67 (d, ³J_{HH}=8.1 Hz, 16H, Ar—H of biphenyl), 8.24 (d, ³J_{HH}=8.1 Hz, 16H, Ar—H of biphenyl).

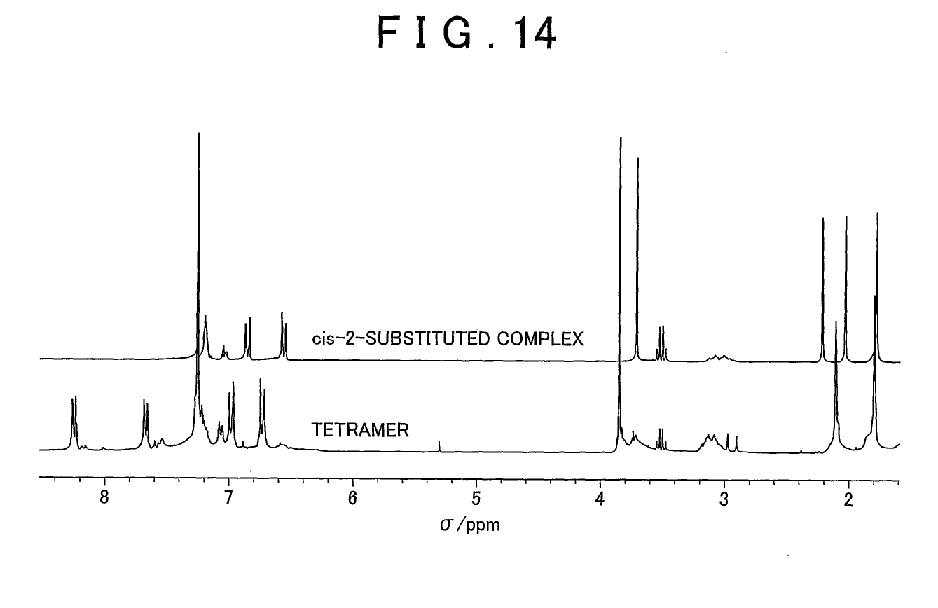

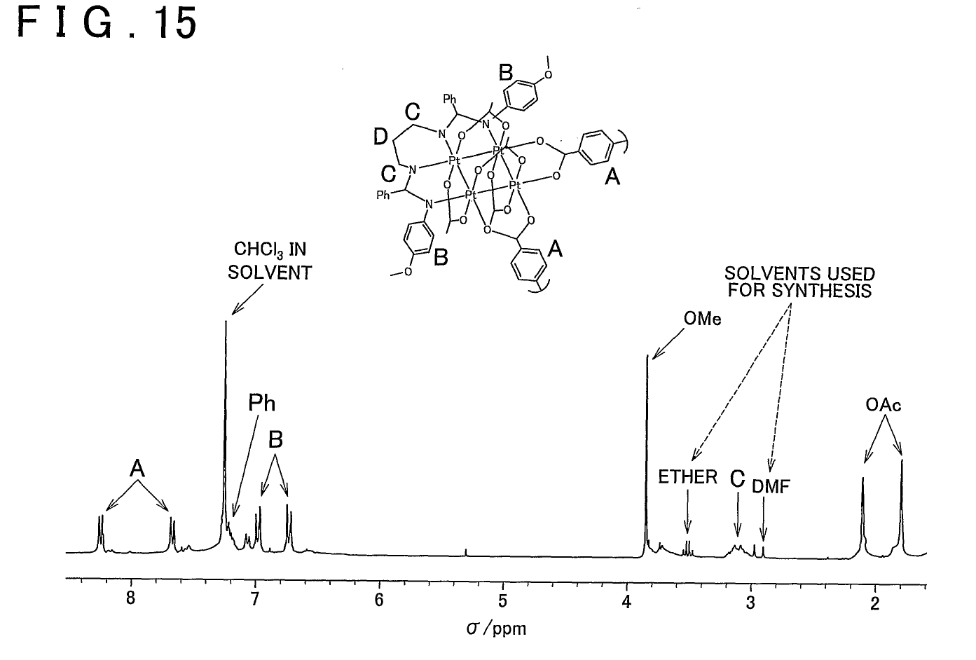

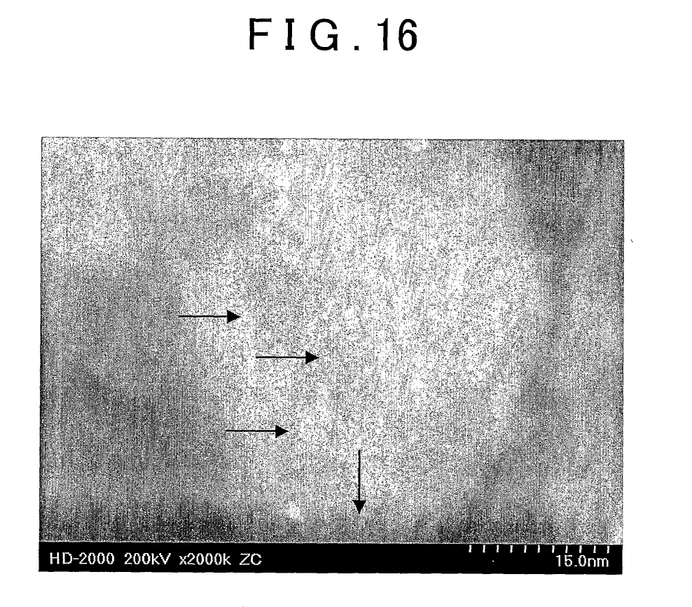

¹H-NMR spectrum charts of a cis-2-substituted complex {Pt₄(CH₃COO)₆(DAniBp)}, that is, a material, and a tetramer of this cis-2-substituted complex, that is, a product, are shown in FIG. 14. For reference, a ¹H-NMR spectrum chart of a cis tetramer that is a product is shown in FIG. 15, together with attributes of signals.

Reference Examples 1 and 2 below show that when a polynuclear complex is fired, a metal or metal oxide cluster having the same number of metals as contained in that complex is obtained, and that when a multiple-complex-containing compound having a plurality of polynuclear complexes is fired, a metal or metal oxide cluster having the same number of metals as contained in that compound is obtained.

### Reference Example 1

Octaacetatotetraplatinum [Pt₄(CH₃COO)₈] was synthesized using a procedure described in “Jikken Kagaku Kouza (Experimental Chemistry Course)”, 4th ed., Vol. 17, p. 452, Maruzen, 1991. Concretely, the synthesis was performed as follows. 5 g of K₂PtCl₄ was dissolved in 20 ml of warm water, and 150 ml of glacial acetic acid was added to the solution. At this time, K₂PtCl₄ began precipitating. Without minding this, 8 g of silver acetate was added. This slurry-like material was refluxed for 3 to 4 hours while being stirred by a stirrer. After the material was let to cool, black precipitation was filtered out. Through the use of a rotary evaporator, acetic acid was removed by concentrating a brown precipitation as much as possible. This concentrate was combined with 50 ml of acetonitrile, and the mixture was left standing. The produced precipitation was filtered out, and the filtrate was concentrated again. Substantially the same operation was performed on the concentrate three times. The final concentrate was combined with 20 ml of dichloromethane, and was subjected to adsorption on a silica gel column. The elution was performed with dichloromethane-acetonitrile (5:1), and a red extract was collected and concentrated to obtain a crystal.

A supporting process will be described. 10 g of magnesium oxide (MgO) was dispersed in 200 g of acetone. While this MgO dispersal solution was being stirred, a solution obtained by dissolving 16.1 mg of [Pt₄(CH₃COO)₈] in 100 g of acetone was added. The mixture was stirred for 10 min. When the stirring was stopped, MgO precipitated and a pale red supernatant was obtained (i.e., [Pt₄(CH₃COO)₈] did not adsorb to MgO). This mixed solution was concentrated and dried by using a rotary evaporator. The dried powder was fired at 400° C. in air for 1.5 hours. The supported concentration of Pt was 0.1 wt %.

The TEM observation of clusters will be described. The appearance of the Pt on the MgO prepared by the foregoing method was observed by TEM. Using an HD-2000 type electron microscope of Hitachi, STEM images were observed at an acceleration voltage of 200 kV. An STEM image of Reference Example 1 is shown in FIG. 16. In this image, Pt particles having a spot diameter of 0.6 nm estimated from the structure of 4-platinum atom clusters can be seen, demonstrating that, by the foregoing technique, 4-platinum atom clusters can be supported on an oxide support.

### Reference Example 2

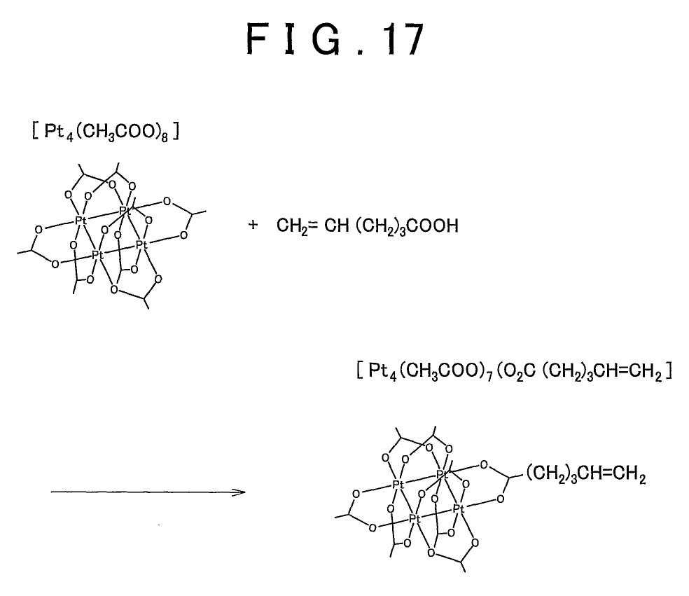

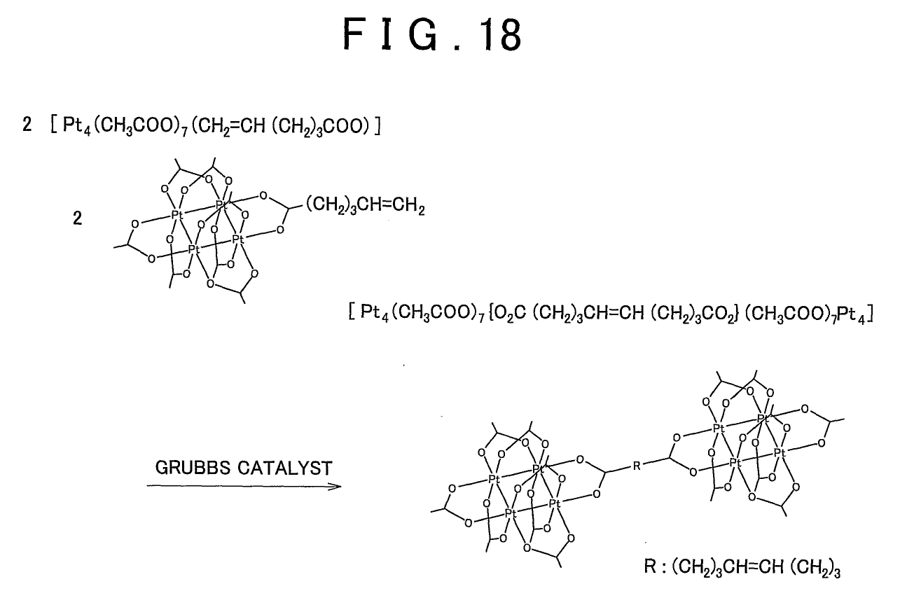

The synthesis of a dimer [Pt₄(CH₃COO)₇{O₂C(CH₂)₃CH═CH(CH₂)₃CO₂}(CH₃COO)₇Pt₄] of octaacetatotetraplatinum was performed in a scheme shown in FIG. 17 and FIG. 18.

Concretely, this compound was synthesized in the following manner. CH₂═CH(CH₂)₃CO₂H (19.4 μL, 18.6 mg) was added to a CH₂Cl₂ solution (10 mL) of the octaacetatotetraplatinum [Pt₄(CH₃COO)₈] (0.204 g, 0.163 mmol) obtained as in Reference Example 1. This changed the color of the solution from orange to red-orange. After the solution was stirred at room temperature for 2 hours, the solvent was removed by evaporation under reduced pressure, and the remaining substance was washed with diethylether (8 mL) twice. As a result, an orange solid of [Pt₄(CH₃COO)₇{O₂C(CH₂)₃CH═CH₂}] was obtained.

[Pt₄(CH₃COO)₇{O₂C(CH₂)₃CH═CH₂}] (362 mg, 0.277 mmol) synthesized as described above and a first-generation Grubbs catalyst (6.7 mg, 8.1 μmol, 2.9 mol %) were placed in an argon-substituted Schlenk flask, and were dissolved in CH₂Cl₂ (30 mL). A cooling pipe was attached to the Schlenk flask, and a heated reflux was performed in an oil bath. After the solution was refluxed for 60 hours, the solvent was removed by evaporation under reduced pressure, and the remaining substance was dissolved in CH₂Cl₂. After that, filtration via a glass filter was performed. The filtrate was concentrated under reduced pressure to obtain a solid. The solid was washed with diethylether (10 mL) three times to obtain an orange solid of a dimer [Pt₄(CH₃COO)₇{O₂C(CH₂)₃CH═CH(CH₂)₃CO₂}(CH₃COO)₇Pt₄] as an E/Z type mixture.

The reaction facilitated by the Grubbs catalyst, that is, the cross-metathesis reaction of reaction, namely carbon-carbon double bonds (olefin), is as follows.

R^{a}R^{b}C═CR^{c}R^{d}+R^{e}R^{f}C═CR^{g}R^{h}

→R^{a}R^{b}C═CR^{g}R^{h}+R^{e}R^{f}C═CR^{c}R^{d}

where R^{a} to R^{h} are independently an organic group such as an alkyl group or the like.

This cross-metathesis reaction and the catalysts used for this reaction are generally known. For example, Japanese Patent Application Publication No. JP-A-2004-123925, Japanese Patent Application Publication No. JP-A-2004-043396, and Published Japanese Translation of PCT application, JP-T-2004-510699 may be referred to. As for the catalyst for the cross-metathesis reaction, the use of a fourth-generation Grubbs catalyst is preferable in that the reaction can be caused to progress under mild conditions.

Spectral data about [Pt₄(CH₃COO)₇{O₂C(CH₂)₃CH═CH₂}]: ¹H NMR (300 MHz, CDCl₃, 308 K) δ: 1.89 (tt, ³J_{HH}=7.5, 7.5 Hz, 2H, O₂CCH₂CH₂—), 1.99 (s, 3H, ^{ax}O₂CCH₃), 2.00 (s, 3H, ^{ax}O₂CCH₃), 2.01 (s, 6H, ^{ax}O₂CCH₃), 2.10 (q like, 2H, —CH₂CH═CH₂), 2.44 (s, 6H, ^{eq}O₂CCH₃), 2.45 (s, 3H, ^{eq}O₂CCH₃), 2.70 (t, ³J_{HH}=7.5 Hz, 2H, O₂CCH₂CH₂—), 4.96 (ddt, ³J_{HH}=10.4 Hz, ²J_{HH}=1.8 Hz, ⁴J_{HH}=? Hz, 1H, —CH═C(H)^{cis}H), 5.01 (ddt, ³J_{HH}=17.3 Hz, ²J_{HH}=1.8 Hz, ⁴J_{HH}? Hz, 1H, —CH═C(H)^{trans}H), 5.81 (ddt, ³J_{HH}=17.3, 10.4, 6.6 Hz, 1H, —CH═CH₂).

¹³C{¹H} NMR (75 MHz, CDCl₃, 308 K) δ: 21.2, 21.2 (^{ax}O₂CCH₃), 22.0, 22.0 (^{eq}O₂CCH₃), 25.8 (O₂CCH₂CH₂—), 33.3 (—CH₂CH═CH₂), 35.5 (O₂CCH₂CH₂—), 115.0 (—CH═CH₂), 137.9 (—CH═CH₂), 187.5, 193.0, 193.1 (O₂CCH₃), 189.9 (O₂CCH₂CH₂—).

MS (ESI+, CH₃CN solution) m/z: 1347 ([M+sol.]⁺).

IR (KBr disk, ν/cm⁻¹): 2931, 2855 (ν_{C—H}), 1562, 1411 (ν_{COO—}), 1039, 917 (ν_{—C═C—}).

Spectral data about [Pt₄(CH₃COO)₇{O₂C(CH₂)₃CH═CH(CH₂)₃CO₂}(CH₃COO)₇Pt₄] Major (E type): ¹H NMR (300 MHz, CDCl₃, 308 K) δ: 1.83 (like, J=7.7 Hz, 4H, O₂CCH₂CH₂—), 2.00 (s, 6H, ^{ax}O₂CCH₃), 2.01 (s, 18H, ^{ax}O₂CCH₃), 2.02-2.10 (m, 4H, —CH₂CH═CH—), 2.44 (s, 18H, ^{eq}O₂CCH₃), 2.67 (t, ³J_{H—H}=7.2 Hz, 4H, O₂CCH₂CH₂—), 5.37-5.45 (m, 2H, —CH═).

¹³C NMR (75 MHz, CDCl₃, 308 K) δ: 21.1₇ (q, ¹J_{C—H}=130.9 Hz, ^{ax}O₂CCH₃), 21.2₂ (q, 1J_{C—H}=131.1 Hz, ^{ax}O₂CCH₃), 21.9 (q, ¹J_{C—H}=129.4 Hz, ^{eq}O₂CCH₃), 22.0 (q, ¹J_{C—H}=129.4 Hz, ^{eq}O₂CCH₃), 26.4 (t, ¹J_{C—H}=127.3 Hz, O₂CCH₂CH₂—), 32.0 (t, ¹J_{C—H}=127.3 Hz, —CH₂CH═CH—), 35.5 (t, 1J_{C—H}=130.2 Hz, O₂CCH₂CH₂—), 130.1 (d, ¹J_{C—H}=148.6 Hz, —CH═), 187.3, 187.4, 193.0 (O₂CCH₃), 189.9 (O₂CCH₂CH₂—).

Minor (Z type): ¹H NMR (300 MHz, CDCl₃, 308 K) δ: 1.83 (like, J=7.7 Hz, 4H, O₂CCH₂CH₂—), 2.00 (s, 6H, ^{ax}O₂CCH₃), 2.01 (s, 18H, ^{ax}O₂CCH₃), 2.02-2.10 (m, 4H, —CH₂CH═CH—), 2.44 (s, 18H, ^{eq}O₂CCH₃), 2.69 (t, ³J_{H—H}=7.2 Hz, 4H, O₂CCH₂CH₂—), 5.37-5.45 (m, 2H, —CH═).

¹³C NMR (75 MHz, CDCl₃, 308 K) δ: 21.1₇ (q, ¹J_{C—H}=130.9 Hz, ^{ax}O₂CCH₃), 21.2₂ (q, ¹J_{C—H}=131.1 Hz, ^{ax}O₂CCH₃), 21.9 (q, ¹J_{C—H}=129.4 Hz, ^{eq}O₂CCH₃), 22.0 (q, ¹J_{C—H}=129.4 Hz, ^{eq}O₂CCH₃), 26.5 (t, ¹J_{C—H}=127.3 Hz, O₂CCH₂CH₂—), 26.7 (t, ¹J_{C—H}=127.3 Hz, —CH₂CH═CH—), 35.5 (t, ¹J_{C—H}=130.2 Hz, O₂CCH₂CH₂—), 129.5 (d, ¹J_{C—H}=154.3 Hz, —CH═), 187.3, 187.4, 193.0 (O₂CCH₃), 189.9 (O₂CCH₂CH₂—).

MS (ESI+, CH₃CN solution) m/z: 2584 ([M]⁺).

The supporting process will be described. 10 g of MgO was dispersed in 200 g of acetone. While this MgO dispersal solution was being stirred, a solution obtained by dissolving 16.6 mg of [Pt₄(CH₃COO)₇{O₂C(CH₂)₃CH═CH(CH₂)₃CO₂}(CH₃COO)₇Pt₄] in 100 g of acetone was added. The mixture was stirred for 10 min. This mixed solution was concentrated and dried by using a rotary evaporator. The dried powder was fired at 400° C. in air for 1.5 hours. The supported concentration of Pt was 0.1 wt %.

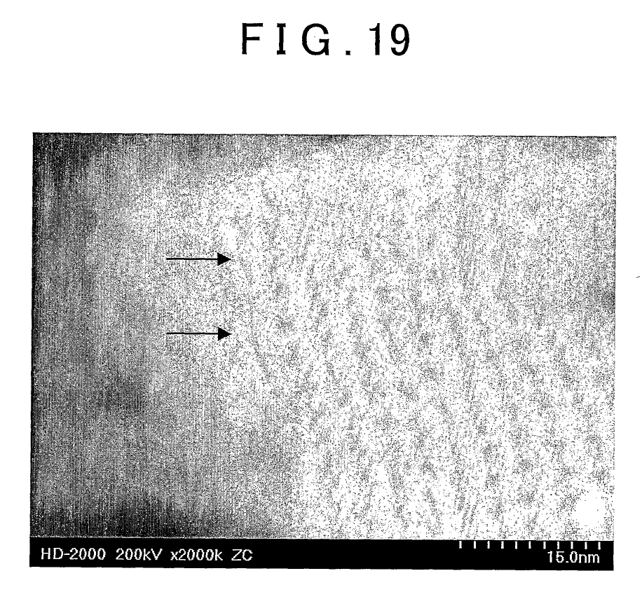

The TEM observation of clusters will be described. The appearance of the Pt on the MgO prepared by the foregoing method was observed by TEM. Using an HD-2000 type electron microscope of Hitachi, STEM images were observed at an acceleration voltage of 200 kV. An STEM image of Reference Example 2 is shown in FIG. 19. In this image, Pt particles having a spot diameter of 0.9 nm estimated from the structure of 8-platinum atom clusters can be seen, demonstrating that, by the foregoing technique, 8-platinum atom clusters can be supported on an oxide support.

While the invention has been described with reference to exemplary embodiments thereof, it should be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. An amidine-carboxylic acid complex, wherein an amidine ligand and a carboxylic acid ligand are coordinated to one metal atom or a plurality of metal atoms of the same element.

2. The amidine-carboxylic acid complex according to claim 1, wherein the carboxylic acid ligand is a monovalent carboxylic acid ligand represented by a formula below: 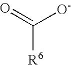
wherein R⁶ is a hydrogen, or a substituted or non-substituted alkyl group, alkenyl group, alkynyl group, aryl group, alicyclic group or aralkyl group.

3. The amidine-carboxylic acid complex according to claim 1, wherein the amidine ligand is a monovalent or polyvalent amidine ligand represented by a formula below: 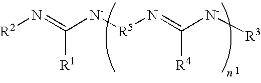
where R¹ to R⁴ each independently are a hydrogen, or a substituted or non-substituted alkyl group, alkenyl group, alkynyl group, aryl group, alicyclic group or aralkyl group, R⁵ is an alkylene group, an alkenylene group, an alkynylene group, an arylene group, an aralkylene group or a bivalent alicyclic group, and n¹ is an integer of 0 to 5.

4. The amidine-carboxylic acid complex according to claim 3, wherein the amidine ligand is a monovalent amidine ligand represented by a formula below:

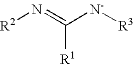

5. The amidine-carboxylic acid complex according to claim 4, wherein R² and R³ each independently are a substituted or non-substituted aryl group or alicyclic group.

6. The amidine-carboxylic acid complex according to claim 5, wherein the amidine-carboxylic acid complex is represented by a formula below:

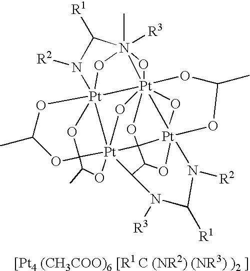

7. The amidine-carboxylic acid complex according to claim 3, wherein the amidine ligand is a bivalent amidine ligand represented by a formula below:

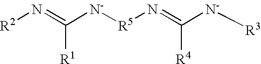

8. The amidine-carboxylic acid complex according to claim 7, wherein R² and R³ each independently are a substituted or non-substituted aryl group or alicyclic group.

9. The amidine-carboxylic acid complex according to claim 8, wherein the amidine ligand is represented by a formula below: 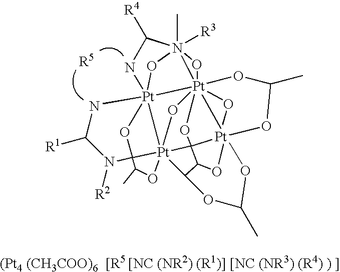
where R⁵ is a substituted or non-substituted alkylene group, alkenylene group or alkynylene group of C₃.

10. A production method for an amidine-carboxylic acid complex, comprising:
providing a carboxylic acid complex in which a plurality of carboxylic acid ligands are coordinated to one metal atom or a plurality of metal atoms of the same element;
providing an amidine ligand supply source; and
substituting partially the carboxylic acid ligands of the carboxylic acid complex with the amidine ligand by mixing the carboxylic acid complex and the amidine ligand supply source in a solvent.

11. A multiple-complex-containing compound, wherein a plurality of amidine-carboxylic acid complexes selected from the group consisting of the amidine-carboxylic acid complex according to claim 1 and their combinations are bound to each other via a polyvalent carboxylic acid ligand substituting at least partially the carboxylic acid ligands.

12. The multiple-complex-containing compound according to claim 11, which has 2 to 1000 metal atoms.

13. The multiple-complex-containing compound according to claim 11, wherein the polyvalent carboxylic acid ligand is a dicarboxylic acid ligand represented by a formula below:
—OOC—R⁷—COO⁻
where R⁷ is an alkylene group, an alkenylene group, an alkynylene group, and arylene group, an aralkylene group, or a bivalent alicyclic group.

14. The multiple-complex-containing compound according to claim 11, wherein the multiple-complex-containing compound is represented by a formula below: 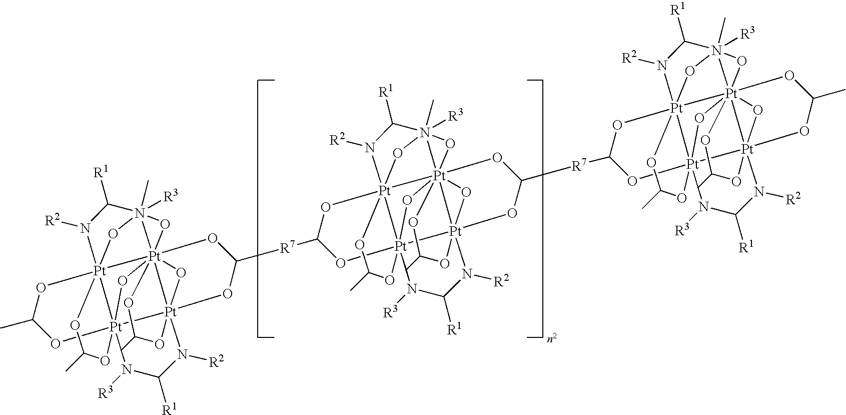
where n² is an integer of 0 to 50.

15. The multiple-complex-containing compound according to claim 13, wherein the multiple-complex-containing compound is represented by a formula below:

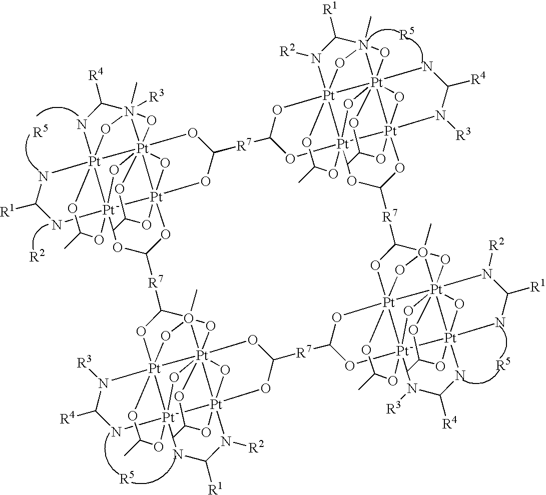

16. A production method for a multiple-complex-containing compound, comprising:
providing an amidine-carboxylic acid complex selected from the group consisting of the amidine-carboxylic acid complex according to claim 1 and their combinations;
providing a polyvalent carboxylic acid ligand source; and
substituting at least partially the carboxylic acid ligand of the amidine-carboxylic acid complex by the polyvalent carboxylic acid ligand, by mixing the amidine-carboxylic acid complex and the polyvalent carboxylic acid ligand source in a solvent.

17. The method according to claim 16, wherein the amount of the polyvalent carboxylic acid ligand source is less than the amount thereof needed in order to entirely substitute the carboxylic acid ligands coordinated in the amidine-carboxylic acid complex.

18. A production method for a metal or metal oxide cluster, comprising:
providing a solution containing a multiple-complex-containing compound according to claim 11; and
removing a ligand or the multiple-complex-containing compound.

19. The method according to claim 18, further comprising:
impregnating a porous support with the solution before removing the ligand of the multiple-complex-containing compound.

20. The method according to claim 18, wherein
the ligand of the multiple-complex-containing compound is removed by drying and firing the solution.
